(19) United States
(12) Patent Application Publication
(10) Pub. No.: US 2023/0006204 A1
(43) Pub. Date: Jan. 5, 2023

(54) ANODE FOR LITHIUM-ION BATTERY AND METHOD OF FABRICATING SAME

(71) Applicant: Sicona Battery Technologies Pty Ltd, Alexandria, New South Wales (AU)

(72) Inventors: Zaiping Guo, Wollongong, New South Wales (AU); Jianfeng Mao, Wollongong, New South Wales (AU); Jingxing Wu, Wollongong, New South Wales (AU)

(21) Appl. No.: 17/784,447

(22) PCT Filed: Dec. 11, 2020
(86) PCT No.: PCT/AU2020/051356

§ 371 Date: Jun. 10, 2022

(30) Foreign Application Priority Data
Dec. 13, 2019 (AU) 2019904719

(51) Int. Cl. H01M 4/583; H01M 10/0525; H01M 4/38; H01M 4/62; H01M 4/04

(52) U.S. Cl. CPC H01M 4/583; H01M 10/0525; H01M 4/386; H01M 4/622; H01M 4/0471; H01M 2004/021

(57) ABSTRACT

Disclosed is a method of fabricating an anode for a lithium-ion battery, including milling a mixture of nano-silicon, one or more carbonaceous materials and one or more solvents, wherein the mixture is retained as a wet slurry during milling. The mixture is carbonised to produce a silicon thinly coated with carbon (Si@C) material. Further milling occurs of a second mixture of the Si@C material, one or more graphite, one or more second carbonaceous materials and one or more second solvents, wherein the second mixture is retained as a second wet slurry during milling. The second mixture is carbonised to produce a Si@C/graphite/carbon material. The anode is formed from the Si@C/graphite/carbon material.

### RELATED APPLICATION

This application claims priority from Australian Provisional Patent Application No. 2019904719 filed 13 Dec. 2019, the contents of which should be understood to be incorporated.

### FIELD OF THE INVENTION

The present invention generally relates to electrochemical cells, and in particular to batteries. In specific examples, the present invention relates to electrodes for use in batteries, for example lithium-ion batteries, i.e., lithium-ion cells, and methods of fabricating electrodes and batteries. More particularly, example embodiments relate to lithium-ion batteries, anodes for lithium-ion batteries, methods of fabricating anodes and lithium-ion batteries, and/or methods of preparing components or materials for use in anodes and lithium-ion batteries.

### BACKGROUND OF THE INVENTION

Any discussion of the prior art throughout the specification should in no way be considered as an admission that such prior art is widely known or forms part of common general knowledge in the field.

Lithium-ion based battery cells are an attractive energy source for various applications, due in part to their ability to provide relatively high energies and long cycle life. Performance characteristics of lithium-ion batteries (LIBs), for example the total energy capacity, depend on the type of anode and cathode used in the LIBs. In the field of anode materials for use in lithium-ion batteries, with a theoretical capacity of up to 4200 mAh/g, silicon has been considered as a promising anode material for next generation LIB s, for example to replace graphite. However, silicon generally suffers from enormous volume change (in the order of 300%) during the lithiation and de-lithiation processes, causing cracking and pulverisation of active materials, followed by disintegration of the anode and leading to rapid degradation of capacity.

Some approaches involving nano-structured silicon (nano-silicon) can alleviate the volume expansion of silicon to some extent, nevertheless, the known synthesis processes involving nano-silicon are relatively complicated, expensive, and difficult to be industrialised.

To achieve improved performance in silicon based anodes in LIBs, particularly high-energy LIBs, important issues to be addressed may include: (a) homogeneous distribution of silicon particles in a conductive matrix; (b) ability for mass production of silicon secondary particles to achieve both high gravimetric and high volumetric energy densities with high initial Coulombic efficiency; and (c) excellent mechanical properties of the anode.

Chinese patent application CN 108807861 A, to Amprius Nanjing Company Limited, discloses a method of fabricating an anode for a lithium-ion battery, comprising the steps of milling a mixture of nano-silicon, one or more carbonaceous materials (paragraph [0028]) and one or more solvents, wherein the mixture is retained as a wet slurry during milling; carbonising the mixture at a carbonisation temperature to produce a silicon coated with carbon (Si@C) material; milling a second mixture of the Si@C material, one or more second carbonaceous materials and one or more second solvents, wherein the second mixture is retained as a second wet slurry during milling; carbonising the second mixture at a second carbonisation temperature to produce a Si@C/carbon material; and forming the anode from the Si@C/carbon material. Although CN'861 describes the silicon as being “nano-silicon”, the silicon used is in the order of 3-4

More specifically, FIG. 1 of CN'861 shows a silicon carbon composite material formed of irregularly-shaped secondary particles obtained from the process described in CN'861. FIG. 1 shows a particle that is surrounded by a continuous amorphous carbon protective layer, inside of which is a plurality of secondary particles composed of a silicon material. Also contained in the particle is a conductive additive, such as carbon nanotubes, dispersed uniformly throughout the mixture. The silicon material and conductive filler are each surrounded by amorphous carbon filler, which is then in turn surrounded by the continuous amorphous carbon protective layer. Accordingly, CN'861 teaches that a uniform, relatively thin coating of nano-silicon is difficult to achieve. A uniform, relatively thin nano-silicon coating is expected to give rise to increased cycle life in the resulting battery.

Zhou, et al. (“Preparation and characterisation of core-shell structure Si/C composite with multiple carbon phases as anode materials for lithium ion batteries”, 2016, J. Alloys and Compounds, vol. 658, pp. 91-97) discloses a lithium ion battery anode comprising modified spherical graphite/silicon/flake graphite/disordered carbon. The active material is prepared by mixing nano-silicon, flake graphite and citric acid then carbonising to obtain Si@CFG, adding modified spherical graphite comprising a layer of coal tar pitch (i.e., graphite and a second carbonaceous material) and performing a second carbonisation step, thereby producing a Si@CFG/spherical graphite/carbon material. Zhou, et al., notably fails to teach that the second mixing step comprises milling. Anode constitution and integrity is relatively crude as a consequence. Thou, et al., further teaches silicon particles not directly coated with carbon, which render them susceptible to expansion and side reactions, which in turn result in lower conductivity.

It is an object of the present invention to overcome or ameliorate at least one of the disadvantages of the prior art, or to provide a useful alternative.

It is an object of an especially preferred form of the present invention to provide for new or improved lithium-ion batteries, anodes for lithium-ion batteries, methods of fabricating anodes and/or lithium-ion batteries, and/or methods of preparing components or materials for use in anodes and/or lithium-ion batteries.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

Although the invention will be described with reference to specific examples it will be appreciated by those skilled in the art that the invention may be embodied in many other forms.

### SUMMARY OF THE INVENTION

This summary is provided to introduce a selection of concepts in a simplified form that are further described below. This summary is not intended to identify key features or essential features of the claimed subject matter, nor is it intended to be used to limit the scope of the claimed subject matter.

According to a first aspect of the present invention there is provided a method of fabricating an anode for a lithium-ion battery, comprising the steps of:

milling a mixture of nano-silicon, one or more carbonaceous materials and one or more solvents, wherein the mixture is retained as a wet slurry during milling;

carbonising the mixture at a carbonisation temperature to produce a silicon thinly coated with carbon (Si@C) material;

milling a second mixture of the Si@C material, graphite, one or more second carbonaceous materials and one or more second solvents, wherein the second mixture is retained as a second wet slurry during milling;

carbonising the second mixture at a second carbonisation temperature to produce a Si@C/graphite/carbon material; and

forming the anode from the Si @ C/graphite/carbon material.

A “thin” coating of Si@C on silicon is generally in the range of about 2 to about 500 Angstroms. In particular, about 5-450, 10-400, 15-350, 20-300, 25-250, 30-200, 35-150, 40-100, or about 45-50 Angstroms. For example, about 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490 or about 500 Angstroms.

In an embodiment, the method further comprises the step of drying the wet slurry at a drying temperature prior to carbonising the mixture.

In an embodiment, the method further comprises the step of drying the second wet slurry at a second drying temperature prior to carbonising the second mixture.

In an embodiment, the mixture is milled by wet ball milling.

In an embodiment, the nano-silicon and the one or more carbonaceous materials are mixed in a mass ratio (nano-silicon:carbonaceous material) of equal to or between about 40:60 to about 70:30.

In an embodiment, the nano-silicon and the one or more carbonaceous materials are mixed in a mass ratio (nano-silicon:carbonaceous material) of about 40:60, 41:59, 42:58, 43:57, 44:56, 45:55, 46:54, 47:53, 48:52, 49:51, about 50:50, 51:49, 52:48, 53:47, 54:46, 55:45, 56:44, 57:43, 58:42, 59:41, about 60:40, 61:39, 62:38, 63:37, 64:36, 65:35, 66:34, 67:33, 68:32, 69:31 or about 70:30.

In an embodiment, the average particle size of the nano-silicon is equal to or between about 50 nm and about 500 nm.

In an embodiment, the average particle size of the nano-silicon is about 50 nm, 100 nm, 150 nm, 200 nm, 250 nm, 300 nm, 350 nm, 400 nm, 450 nm or 500 nm.

In an embodiment, the average particle size of the nano-silicon is about 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490 or 500 nm.

In an embodiment, the one or more solvents are one or more inert solvents such as, e.g., ethylene glycol (EG), 1-pentanol, propylene glycol and polyacrylic acid.

In an embodiment, the one or more solvents are selected from the group consisting of toluene, xylene, quinoline, pyridine and tetrahydrofuran (THF), diethyl ether, di-isopropyl ether, methylethyl ether, dioxane, methanol, ethanol, 1-propanol, isopropanol, n-butanol, t-butanol, ethyl acetate, dimethylacetamide (DMA), dimethylformamide (DMF), dimethylsulfoxide (DMSO), pentane, n-hexanes, cyclohexane, acetonitrile, acetone, chloroform, dichloromethane carbon tetrachloride, ethylene glycol (EG), propylene glycol, polyacrylic acid, or mixtures thereof.

In an embodiment, the one or more carbonaceous materials are selected from the group consisting of functionalised graphene platelets, carbon nanotubes (CNTs), reduced graphene oxide (rGO), pyrolysed carbon derived from precursors of glucose, sucrose or critic acid (CA), pitch, polyacrylonitrile (PAN), polyvinyl chloride (PVC), poly(diallyldimethylammonium chloride) (PDDA), poly(sodium 4-styrenesulfonate) (PSS)), polydopamine (PDA), polypyrrole (PPy) and phenolic resin.

In an embodiment, the graphite is flake graphite or graphite microspheres.

In an embodiment, the graphite microspheres have an average size of equal to or between about 1 μm and about 20 pm.

In an embodiment, the graphite microspheres have an average size of about 1 μm, 5 μm, 10 μm, 15 μm or 20 μm.

In an embodiment, the graphite microspheres have an average size of about 1, 2, 3, 4, 5, 6, 7, 8, 9, 10, 11, 12, 13, 14, 15, 16, 17, 18, 19 or 20 μm.

In an embodiment, the wet slurry is vacuum dried in an oven.

In an embodiment, the drying temperature is equal to or between about 70° C. and about 150° C.

In an embodiment, the drying temperature is about 70° C., 80° C., 90° C., 100° C., 110° C., 120° C., 130° C., 140° C. or 150° C.

In an embodiment, the drying temperature is about 70, 75, 80, 85, 90, 95, 100, 105, 110, 115, 120, 125, 130, 135, 140, 145 or 150° C.

In an embodiment, the step/s of carbonising the mixture occurs in a tube furnace under a flowing inert gas.

In an embodiment, the inert gas is nitrogen gas, argon gas or mixtures thereof. In an embodiment, the inert gas is argon gas.

In an embodiment, the carbonisation temperature is equal to or between about 900° C. to about 1200° C.

In an embodiment, the carbonisation temperature is about 900° C., 950° C., 1000° C., 1050° C., 1100° C., 1150° C. or 1200° C.

In an embodiment, the carbonisation temperature is about 900, 925, 950, 975, 1000, 1025, 1050, 1075, 1100, 1125, 1150, 1175 or 1200° C.

In an embodiment, the mixture is carbonised at the carbonisation temperature for a time of equal to or between about 3 hours to about 8 hours. In an embodiment, the mixture is carbonised at the carbonisation temperature for a time of about 3, 3.5, 4, 4.5, 5, 5.5, 6, 6.5, 7, 7.5 or 8 hours.

In an embodiment, before the carbonisation temperature is reached, the mixture is held at a holding temperature that is less than the carbonisation temperature.

In an embodiment, the holding temperature is equal to or between about 300° C. to about 500° C.

In an embodiment, the holding temperature is about 300, 310, 320, 330, 340, 350, 360, 370, 380, 390, 400, 410, 420, 430, 440, 450, 460, 470, 480, 490 or about 500° C.

In an embodiment, the Si@C material, the graphite and the one or more second carbonaceous materials are mixed in a mass ratio (Si@C material:graphite:second carbonaceous material) of equal to or between about 10-30:40-80:10-30.

In an embodiment, the Si@C material, the graphite and the one or more second carbonaceous materials are mixed in a mass ratio (Si@C material:graphite:second carbonaceous material) about 10-30:40-80:10-30.

In an embodiment, the Si@C material, the graphite and the one or more second carbonaceous materials are mixed in a mass ratio (Si@C material:graphite:second carbonaceous material) of about 10:80:10, about 10:70:20, about 10:60:30, about 20:70:10, about 20:60:20, about 20:50:30, about 30:60:10, about 30:50:20 or about 30:40:30.

In an embodiment, the second mixture is milled by wet ball milling.

In an embodiment, the one or more second solvents are one or more inert solvents, such as, e.g., ethylene glycol (EG), 1-pentanol, propylene glycol and polyacrylic acid.

In an embodiment, the one or more second solvents are selected from the group consisting of toluene, xylene, quinoline, pyridine and tetrahydrofuran (THF), diethyl ether, di-isopropyl ether, methylethyl ether, dioxane, methanol, ethanol, 1-propanol, isopropanol, n-butanol, t-butanol, ethyl acetate, dimethylacetamide (DMA), dimethylformamide (DMF), dimethylsulfoxide (DMSO), pentane, n-hexanes, cyclohexane, acetonitrile, acetone, chloroform, dichloromethane carbon tetrachloride, ethylene glycol (EG), propylene glycol, polyacrylic acid, or mixtures thereof.

In an embodiment, the one or more second carbonaceous materials are the same as the one or more carbonaceous materials.

In an embodiment, the one or more second carbonaceous materials are different to the one or more carbonaceous materials.

In an embodiment, the one or more second solvents are the same as the one or more solvents.

In an embodiment, the one or more second solvents are different to the one or more solvents.

In an embodiment, the second drying temperature is equal to or between about 70° C. and about 150° C.

In an embodiment, the second drying temperature is about 70° C., 80° C., 90° C., 100° C., 110° C., 120° C., 130° C., 140° C. or 150° C.

In an embodiment, the second drying temperature is about 70, 75, 80, 85, 90, 95, 100, 105, 110, 115, 120, 125, 130, 135, 140, 145 or 150° C.

In an embodiment, carbonising the second mixture occurs in a tube furnace under a flowing inert gas.

In an embodiment, the inert gas is nitrogen gas, argon gas or mixtures thereof. In an embodiment, the inert gas is argon gas or nitrogen gas.

In an embodiment, the second carbonisation temperature is equal to or between about 900° C. to about 1200° C.

In an embodiment, the second carbonisation temperature is about 900° C., 950° C., 1000° C., 1050° C., 1100° C., 1150° C. or 1200° C.

In an embodiment, the second carbonisation temperature is about 900, 925, 950, 975, 1000, 1025, 1050, 1075, 1100, 1125, 1150, 1175 or 1200° C.

In an embodiment, the second mixture is carbonised at the second carbonisation temperature for a time of equal to or between about 3 hours to about 8 hours.

In an embodiment, the second mixture is carbonised at the carbonisation temperature for a time of about 3, 3.5, 4, 4.5, 5, 5.5, 6, 6.5, 7, 7.5 or 8 hours.

In an embodiment, before the second carbonisation temperature is reached, the second mixture is held at a second holding temperature that is less than the second carbonisation temperature.

In an embodiment, the second holding temperature is equal to or between about 300° C. to about 500° C.

In an embodiment, the second holding temperature is about 300, 310, 320, 330, 340, 350, 360, 370, 380, 390, 400, 410, 420, 430, 440, 450, 460, 470, 480, 490 or about 500° C.

In an embodiment, the method further comprises the step of milling the Si@C/graphite/carbon material.

In an embodiment, the milling is by dry ball milling.

In an embodiment, the method further comprises the step of mixing the Si@C/graphite/carbon material with one or more polymer binders.

In an embodiment, the one or more polymer binders include one or more linear polymers, one or more conductive polymers, one or more self-healing polymers, and one or more rubber polymers.

In an embodiment, the anode is formed by:

mixing the Si@C/graphite/carbon material and the one or more polymer binders to produce a slurry;

coating the slurry onto a metallic member; and

drying the metallic member with coated slurry to form the anode.

According to a second aspect of the present invention there is provided a method of fabricating an anode for a lithium-ion battery, comprising the steps of:

mixing micro-silicon and one or more inert solvents to produce a wet slurry mixture; and

milling the wet slurry mixture of the micro-silicon and the one or more inert solvents to obtain nano-silicon, wherein the mixture is retained as a wet slurry mixture during milling;

milling a mixture of the nano-silicon, one or more carbonaceous materials and one or more solvents, wherein the mixture is retained as a wet slurry during milling;

carbonising the mixture at a carbonisation temperature to produce a silicon coated with carbon (Si@C) material;

milling a second mixture of the Si @ C material, graphite, one or more second carbonaceous materials and one or more second solvents, wherein the second mixture is retained as a second wet slurry during milling;

carbonising the second mixture at a second carbonisation temperature to produce a Si@C/graphite/carbon material;

mixing the Si@C/graphite/carbon material, one or more linear polymers, one or more conductive polymers, one or more self-healing polymers, and one or more rubber polymers to produce a slurry;

coating the slurry onto a metallic member; and

drying the metallic member with coated slurry to form the anode.

In an embodiment, the mixture is milled by wet ball milling.

In an embodiment, the nano-silicon and the one or more carbonaceous materials are mixed in a mass ratio (nano-silicon:carbonaceous material) of equal to or between about 40:60 to about 70:30.

In an embodiment, the nano-silicon and the one or more carbonaceous materials are mixed in a mass ratio (nano-silicon:carbonaceous material) of about 40:60, 41:59, 42:58, 43:57, 44:56, 45:55, 46:54, 47:53, 48:52, 49:51, about 50:50, 51:49, 52:48, 53:47, 54:46, 55:45, 56:44, 57:43, 58:42, 59:41, about 60:40, 61:39, 62:38, 63:37, 64:36, 65:35, 66:34, 67:33, 68:32, 69:31 or about 70:30.

In an embodiment, the average particle size of the nano-silicon is equal to or between about 50 nm and about 500 nm.

In an embodiment, the average particle size of the nano-silicon is about 50 nm, 100 nm, 150 nm, 200 nm, 250 nm, 300 nm, 350 nm, 400 nm, 450 nm or 500 nm.

In an embodiment, the average particle size of the nano-silicon is about 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490 or 500 nm.

In an embodiment, the one or more solvents are one or more inert solvents.

In an embodiment, the one or more solvents are selected from the group consisting of toluene, xylenes, quinoline, pyridine and tetrahydrofuran (THF), diethyl ether, di-isopropyl ether, methylethyl ether, dioxane, methanol, ethanol, 1-propanol, isopropanol, n-butanol, t-butanol, ethyl acetate, dimethylacetamide (DMA), dimethylformamide (DMF), dimethylsulfoxide (DMSO), pentane, n-hexanes, cyclohexane, acetonitrile, acetone, chloroform, dichloromethane carbon tetrachloride, ethylene glycol (EG), propylene glycol, polyacrylic acid, or mixtures thereof.

In an embodiment, the one or more carbonaceous materials are selected from the group consisting of functionalised graphene platelets, carbon nanotubes (CNTs), reduced graphene oxide (rGO), pyrolysed carbon derived from precursors of glucose, sucrose or critic acid (CA), pitch, polyacrylonitrile (PAN), polyvinyl chloride (PVC), poly(diallyl dimethylammonium chloride) (PDDA), poly(sodium 4-styrenesulfonate) (PSS)), polydopamine (PDA), polypyrrole (PPy) and phenolic resin.

In an embodiment, the graphite is flake graphite or graphite microspheres.

In an embodiment, the graphite microspheres have an average size of equal to or between about 1 μm and about 20 μm.

In an embodiment, the graphite microspheres have an average size of about 1 μm, 5 μm, 10 μm, 15 μm or 20 μm.

In an embodiment, the graphite microspheres have an average size of about 1, 2, 3, 4, 5, 6, 7, 8, 9, 10, 11, 12, 13, 14, 15, 16, 17, 18, 19 or 20 μm

In an embodiment, the wet slurry is vacuum dried in an oven.

In an embodiment, the drying temperature is equal to or between about 70° C. and about 150° C.

In an embodiment, the drying temperature is about 70° C., 80° C., 90° C., 100° C., 110° C., 120° C., 130° C., 140° C. or 150° C.

In an embodiment, the drying temperature is about 70, 75, 80, 85, 90, 95, 100, 105, 110, 115, 120, 125, 130, 135, 140, 145 or 150° C.

In an embodiment, the step/s of carbonising the mixture occurs in a tube furnace under a flowing inert gas.

In an embodiment, the inert gas is argon gas, nitrogen gas or mixtures thereof.

In an embodiment, the carbonisation temperature is equal to or between about 900° C. to about 1200° C.

In an embodiment, the carbonisation temperature is about 900° C., 950° C., 1000° C., 1050° C., 1100° C., 1150° C. or 1200° C.

In an embodiment, the carbonisation temperature is about 900, 925, 950, 975, 1000, 1025, 1050, 1075, 1100, 1125, 1150, 1175 or 1200° C.

In an embodiment, the mixture is carbonised at the carbonisation temperature for a time of equal to or between about 3 hours to about 8 hours. In an embodiment, the mixture is carbonised at the carbonisation temperature for a time of about 3, 3.5, 4, 4.5, 5, 5.5, 6, 6.5, 7, 7.5 or 8 hours.

In an embodiment, before the carbonisation temperature is reached, the mixture is held at a holding temperature that is less than the carbonisation temperature.

In an embodiment, the holding temperature is equal to or between about 300° C. to about 500° C.

In an embodiment, the holding temperature is about 300, 310, 320, 330, 340, 350, 360, 370, 380, 390, 400, 410, 420, 430, 440, 450, 460, 470, 480, 490 or about 500° C.

In an embodiment, the Si@C material, the graphite and the one or more second carbonaceous materials are mixed in a mass ratio (Si@C material:graphite:second carbonaceous material) of equal to or between about 10-30:40-80:10-30.

In an embodiment, the Si@C material, the graphite and the one or more second carbonaceous materials are mixed in a mass ratio (Si@C material:graphite:second carbonaceous material) about 10-30:40-80:10-30.

In an embodiment, the Si@C material, the graphite and the one or more second carbonaceous materials are mixed in a mass ratio (Si@C material:graphite:second carbonaceous material) of about 10:80:10, about 10:70:20, about 10:60:30, about 20:70:10, about 20:60:20, about 20:50:30, about 30:60:10, about 30:50:20 or about 30:40:30.

In an embodiment, the second mixture is milled by wet ball milling.

In an embodiment, the one or more second solvents are one or more inert solvents.

In an embodiment, the one or more second solvents are selected from the group consisting of toluene, xylene, quinoline, pyridine and tetrahydrofuran (THF), diethyl ether, di-isopropyl ether, methylethyl ether, dioxane, methanol, ethanol, 1-propanol, isopropanol, n-butanol, t-butanol, ethyl acetate, dimethylacetamide (DMA), dimethylformamide (DMF), dimethylsulfoxide (DMSO), pentane, n-hexanes, cyclohexane, acetonitrile, acetone, chloroform, dichloromethane carbon tetrachloride, ethylene glycol (EG), propylene glycol, polyacrylic acid, or mixtures thereof.

In an embodiment, the one or more second carbonaceous materials are the same as the one or more carbonaceous materials.

In an embodiment, the one or more second carbonaceous materials are different to the one or more carbonaceous materials.

In an embodiment, the one or more second solvents are the same as the one or more solvents.

In an embodiment, the one or more second solvents are different to the one or more solvents.

In an embodiment, the second drying temperature is equal to or between about 70° C. and about 150° C.

In an embodiment, the second drying temperature is about 70° C., 80° C., 90° C., 100° C., 110° C., 120° C., 130° C., 140° C. or 150° C.

In an embodiment, the second drying temperature is about 70, 75, 80, 85, 90, 95, 100, 105, 110, 115, 120, 125, 130, 135, 140, 145 or 150° C.

In an embodiment, carbonising the second mixture occurs in a tube furnace under a flowing inert gas.

In an embodiment, the inert gas is argon gas, nitrogen gas or mixtures thereof.

In an embodiment, the second carbonisation temperature is equal to or between about 900° C. to about 1200° C.

In an embodiment, the second carbonisation temperature is about 900° C., 950° C., 1000° C., 1050° C., 1100° C., 1150° C. or 1200° C.

In an embodiment, the second carbonisation temperature is about 900, 925, 950, 975, 1000, 1025, 1050, 1075, 1100, 1125, 1150, 1175 or 1200° C.

In an embodiment, the second mixture is carbonised at the second carbonisation temperature for a time of equal to or between about 3 hours to about 8 hours.

In an embodiment, the second mixture is carbonised at the carbonisation temperature for a time of about 3, 3.5, 4, 4.5, 5, 5.5, 6, 6.5, 7, 7.5 or 8 hours.

In an embodiment, before the second carbonisation temperature is reached, the second mixture is held at a second holding temperature that is less than the second carbonisation temperature.

In an embodiment, the second holding temperature is equal to or between about 300° C. to about 500° C.

In an embodiment, the second holding temperature is about 300, 310, 320, 330, 340, 350, 360, 370, 380, 390, 400, 410, 420, 430, 440, 450, 460, 470, 480, 490 or about 500° C.

In an embodiment, the method further comprises the step of milling the Si@C/graphite/carbon material.

In an embodiment, the milling is by dry ball milling.

In an embodiment, the method further comprises the step of mixing the

Si@C/graphite/carbon material with one or more polymer binders.

In an embodiment, the one or more polymer binders include one or more linear polymers, one or more conductive polymers, one or more self-healing polymers, and one or more rubber polymers.

In an embodiment, the anode is formed by:

mixing the Si@C/graphite/carbon material and the one or more polymer binders to produce a slurry;

coating the slurry onto a metallic member; and

drying the metallic member with coated slurry to form the anode.

According to a third aspect of the present invention there is provided an anode for a lithium-ion battery, when produced by the method of the first or second aspects of the present invention.

According to a fourth aspect of the present invention there is provided an anode for a lithium-ion battery, comprising a Si@C/graphite/carbon material.

According to a fifth aspect of the present invention there is provided a lithium-ion battery, comprising:

an anode as defined according to the third or fourth aspects of the invention;

a cathode; and one or more of an electrolyte, or a mixture thereof, and/or one or more of a separator, or a mixture thereof, positioned between the anode and the cathode.

An example non-limiting electrolyte includes 1.15 M LiPF₆ in a mixture of ethylene carbonate (EC)/ethyl methyl carbonate (EMC)/ethyl propionate (EP)/fluoroethylene carbonate (FEC) in a weight ratio of 27:35:27:10 (ethylene carbonate (EC): ethyl methyl carbonate (EMC):ethyl propionate (EP):fluoroethylene carbonate (FEC)), with additive agents such as, for example, propylene sulfate (PS) and adiponitrile (AND).

As will be apparent to those skilled in the art, a separator is a physical barrier that keeps two sides of the battery apart whilst allowing ion transfer only. Non-limiting examples of separators include polymer separators, in particular, multilayer polymer separators and more particularly, polyethylene multilayer polymer separators.

In other examples, the method further includes: drying the wet slurry at a drying temperature prior to carbonising the mixture, and/or drying the second wet slurry at a second drying temperature prior to carbonising the second mixture. In another example, the mixture is milled by wet ball milling, and/or the second mixture is milled by wet ball milling. Optionally, but preferably, the one or more solvents and/or the one or more second solvents are one or more inert solvents.

In other examples, the one or more second carbonaceous materials are the same as the one or more carbonaceous materials; the one or more second carbonaceous materials are different to the one or more carbonaceous materials; the one or more second solvents are the same as the one or more solvents; or the one or more second solvents are different to the one or more solvents.

In other examples, before the carbonisation temperature is reached, the mixture is held at a holding temperature that is less than the carbonisation temperature, and/or before the second carbonisation temperature is reached, the second mixture is held at a second holding temperature that is less than the second carbonisation temperature.

In another example, the resulting Si@C/graphite/carbon material is further milled, preferably by dry ball milling. In another example, the Si@C/graphite/carbon material is mixed with one or more polymer binders in fabricating the anode. In another example, the anode is formed by: mixing the Si@C/graphite/carbon material and the one or more polymer binders to produce a slurry; coating the slurry onto a metallic member; and drying the metallic member with coated slurry to form the anode. In further examples, the metallic member is a metallic foil, strip or grid. In another example, a conductive agent is mixed into the slurry.

Other aspects, features, and advantages will become apparent from the following descriptive sections when taken in conjunction with the accompanying drawings, which are a part of this disclosure and which illustrate, by way of example, principles of the various embodiments.

### BRIEF DESCRIPTION OF THE FIGURES

A preferred embodiment of the invention will now be described, which is given by way of example only, of at least one non-limiting embodiment, described in connection with the accompanying Figures.

FIG. 1 illustrates a flow diagram of an example method of producing nano-silicon from micro-silicon.

FIG. 2 illustrates a flow diagram of an example method of fabricating an anode comprising a silicon/carbon/graphite material for a lithium-ion battery.

FIG. 3 is an exemplary representation of an embodiment of the resulting Si@C/G/C structure of the present invention.

FIG. 4 illustrates an example lithium-ion battery, i.e., lithium-ion cell, including an anode fabricated according to one of the example methods disclosed herein.

FIG. 5(a) illustrates the cycling performance of an example anode (labelled Si@C/G/C-1) versus FIG. 5(b) an example electrode (labelled Si/G-1) both of which used a standard industry CMC/SBR binder. The Si@C/G/C-1 anode delivered an average reversible discharge capacity (i.e., specific capacity) of 522.17 mAh/g over 400 cycles. The initial CE is 80.56%, the CE exceeded 99.0% after 25 cycles and 72.6% of capacity is retained after 400 cycles. The Si/C/G-1 anode delivered an average discharge capacity of 510.17 mAh/g over 400 cycles, and a retention of capacity of 70.67%. This result proved that double carbon coating (e.g., as used in Example 1) is beneficial to the electrochemical performance of an anode.

FIG. 6 illustrates the cycling performance of an example anode (Example 3) labelled a Si@C/G/C-2 anode. The discharge capacity falls rapidly, and the retention capacity is quite low. It is believed that dry ball milling (i.e., without use of one or more solvents) leads to uneven coating and thus some silicon particles are directly exposed to electrolytes, and that these uncoated silicon particles result in degraded electrochemical performance and poorer cycling ability compared to Example 1.

FIG. 7 illustrates the cycling performance of example anodes labelled a Si/G-1 anode (Example 4) and a Si-1 anode (Example 5). The Si/G-1 anode and the Si-1 anode can deliver high reversible capacities during initial cycling, but the reversible capacities rapidly decrease after further cycling. Only 28.5% (Si/G-1 anode) and 8.3% (the Si-1 anode) of capacity is retained after 100 cycles.

FIG. 8 illustrates the cycling performance of example anodes labelled a Si@C/G/C-3 anode (Example 6) and a Si@C/G/C-4 anode (Example 7). In comparison with the Si@C/G/C-1 anode (Example 1), the Si@C/G/C-3 anode and the Si@C/G/C-4 anode deliver lower capacity retention, retaining 86.01% (Si@C/G/C-3 anode) and 81.47% (Si@C/G/C-4 anode) of capacity after 100 cycles, and 71.4% (Si@CIG/C-3 anode) and of 40.65% (Si@C/G/C-4 anode) capacity after 250 cycles.

FIG. 9 illustrates a flow diagram of an example method of producing a multi-functional polymer binder.

FIG. 10 illustrates a flow diagram of an example method of fabricating an anode for a lithium-ion battery. Step 1010 includes mixing a silicon/graphite/carbon material, one or more linear polymers, one or more conductive polymers, one or more self-healing polymers, and one or more rubber polymers to produce a slurry.

FIG. 11 illustrates a flow diagram of an example method of fabricating an anode with a binder for a lithium-ion battery.

FIG. 12(a) illustrates the cycling performance of an example anode (Example 8) labelled a Si@C/G/C-5 anode. The Si@C/G/C-5 anode delivered an average reversible discharge capacity of about 525.7 mAh/g over 250 cycles. CE exceed 99.0% after 13 cycles, and 95.35% of capacity can be retained after 100 cycles, and 89.2% of capacity was retained after 250 cycles, which is an improved electrochemical performance compared to the Si@C/G/C-1 anode (Example 1).

FIG. 12(b) illustrates the cycling performance of an example anode with the LSCR binder (Example 8) labelled a Si@C/G/C-5 (i.e., a “5:1”) anode over 400 cycles. 82.8% of capacity was retained after 400 cycles, which is an improved electrochemical performance compared to the Si@C/G/C-1 anode, over 400 cycles.

FIG. 13 illustrates the cycling performance of Si@C/G/C-5 with various binders at 0.3 C (200 mA/g). The Si@C/G/C-5 anode was prepared in the same way as for Si@C/G/C-1 (Example 1) except new graphite (natural graphite) was used in the composite. Si@C/G/C-5 with LSCR binder (# 1) can maintain 88.0% capacity over 100 cycles, which is higher than 72.8% of Si@C/G/C-5 with LSC (without SBR) binder (# 2), 68.4% of Si@C/G/C-5 with CMC+SBR binder (# 3) and 63.4% % of Si@C/G/C-5 with CMC binder (# 4). The result proved that this innovative binder is beneficial to capacity retention of Si/C composite anode.

FIG. 14 illustrates the rate performance of Si@C/G/C-5 with various binders at 0.3 C (200 mA/g), referring to FIG. 13, above, the Si@C/G/C-5 anode was prepared in the same way as for Si@C/G/C-1 (Example 1) except new graphite (natural graphite) was used in the composite. Si@C/G/C-5 with LSCR binder (# 1) can deliver a specific capacity of 606, 581, 559, 522, 376 and 241 mAh/g at 0.15 C, 0.3 C, 0.45 C, 0.75 C, 1.5 C, 3 C, respectively, which outperforms the electrodes with LSC binder (# 2), CMC+SBR binder (# 3) and CMC binder (# 4), while the electrode with CMC binder (# 4) delivered the lowest capacities of 234 and 146 mAh/g at 1.5 C, 3 C, respectively.

FIG. 15 illustrates the cycling performance of Si@C/G/C-6, Si@C/G/C-7 and Si@C/G/C-8. These three anodes were prepared in a similar way to the Si@C/G/C-1 (Example 1), except different annealing temperatures and new graphite (natural graphite) were used. The annealing temperatures used during carbonisation were 1000° C. for Si@C/G/C-6, 900° C. for Si@C/G/C-7 and 700° C. for Si@C/G/C-8. Si@C/G/C-6 delivered the highest capacity retention, retaining 81.3% of capacity after 100 cycles, while Si@C/G/C-7, Si@C/G/C-8 retained just 77.8% and 68.9%, respectively.

FIG. 16 compares the SEM images of fresh and 100 cycled Si@C/G/C-5 anode with different binders. FIG. 16(a) and (b) refer to fresh and 100 cycled Si@C/G/C-5 anode with CMC binder; (c) and (d) CMC+SBR binder; (e) and (f) LSC binder; (g) and (h) LSCR binder. FIG. 16(b) and (d) show clear microcracks all over the electrode surface, while no obvious cracks are observed in the case of LSCR binder after 100 cycles, indicating better electrode integrity after 100 charge/discharge cycles.

FIG. 17 compares the viscosity of different binders, SBR binder shows the lowest viscosity, while LSCR binder displays the highest viscosity, this result proved that the LSCR binder is beneficial to endure the stress caused by the volume change during cycling and maintain the integrity of the anode.

### DETAILED DESCRIPTION AND EXAMPLES

The following modes, given by way of example only, are described in order to provide a more precise understanding of the subject matter of an embodiment or embodiments. In the Figures, incorporated to illustrate features of an example embodiment, like reference numerals are used to identify like parts throughout the Figures.

In one example a silicon/carbon/graphite (i.e., Si@C/G/C or Si/C/G) material is fabricated or formed for use as an anode in a lithium-ion battery (LIB) (i.e., a lithium-ion cell). The silicon/carbon/graphite material can be formed by using silicon and one or more carbonaceous materials and graphite. In various example methods of fabricating an anode the silicon content and distribution in the composite material forming the anode significantly affects the overall properties of the anode. For example, there can be a trade-off between the capacity of the anode and the stability of the anode. Therefore, selection of the type and content ratio of carbonaceous raw materials (i.e., one or more carbonaceous materials), selection of the type and content ratio of silicon, selection of the content ratio of graphite, the coating process, the mixing process, and other processes utilised, can be important aspects in achieving improved performance of an anode for application in commercial LIBs.

To achieve a high performance anode, such as an anode formed of silicon/carbon/graphite materials, for example to replace known graphite anodes in LIBs, the inventors have addressed problems associated with: (a) achieving homogeneous distribution of silicon particles in a conductive matrix, such as graphite and carbon; (b) mass production of silicon secondary particles to achieve both high gravimetric and high volumetric energy densities with high initial Coulombic efficiency; and/or (c) excellent mechanical properties of the anode, in a particular example by utilising a cohesive, elastic, conductive and self-healing polymer binder to achieve a long cycle life of the anode.

In example embodiments, anodes formed of different silicon/carbon/graphite materials are synthesised (i.e., fabricated) using novel methods. For example, an anode formed of a “double carbon coated” silicon/carbon/graphite (i.e., Si@C/G/C) material is fabricated using novel methods.

References to Si/C/G and Si@C/G/C are intended to refer to a “silicon/carbon/graphite” material that is formed of or based on components of silicon (Si), carbon (C), and graphite (G). References to Si@C are intended to refer to carbon-covered silicon particles (i.e., silicon coated or covered with carbon material). For example, in a Si@C material a carbon shell or layer covers a silicon core, which avoids direct contact between the silicon surface and an electrolyte. Specifically, references to Si@C/G/C are intended to refer to a material that is formed of or based on components of a Si@C material, graphite (G) and carbon (C).

In another example embodiment there is provided a method of fabricating an anode for application in a lithium-ion battery, the anode comprising a Si@C/G/C material, and the method including:

using a specified weight ratio range of nano-silicon:carbonaceous material;

milling, for example wet ball milling, the nano-silicon and carbonaceous material together with one or more solvents, which may be one or more inert solvents;

retaining (i.e., maintaining) the mixture as a wet slurry during milling, for example wet ball milling;

drying the wet slurry at a drying temperature for a drying time;

carbonisation/sintering of the dried Si/C mixture at a carbonisation temperature being within a carbonisation temperature range to produce a Si@C material (i.e., silicon particles coated with carbon);

using a specified weight ratio range of (Si@C material):graphite:carbonaceous material;

milling (i.e., for a second time), for example wet ball milling, the Si@C material and graphite and second carbonaceous material, which could be the same carbonaceous material as previously used or a different carbonaceous material, together with one or more second solvents, which may be one or more second inert solvents, and where the one or more second solvents could be the same as or different to the one or more solvents;

retaining (i.e., maintaining) the mixture of Si@C, graphite and carbonaceous material as a wet slurry during milling, for example wet ball milling;

drying the wet slurry at a second drying temperature for a second drying time;

carbonisation/sintering (i.e., for a second time) of the Si@C/G/C mixture (i.e., a second mixture) at a second carbonisation temperature being within a second carbonisation temperature range, where the second carbonisation temperature may be the same as, or different to, the carbonisation temperature and the second carbonisation temperature range may be the same as, or different to, the carbonisation temperature range; and

forming the anode from the resulting Si@C/G/C material, for example by compacting the Si@C/G/C material.

### EXPERIMENTAL a) Preparation of nano-silicon

In one example, a method of producing nano-silicon from micro-silicon comprises milling, for example sand milling or ball milling, micro-silicon mixed with an inert solvent and retaining the mixture as a wet slurry during milling of the micro-silicon. Use of the inert solvent avoids oxidation of the produced nano-silicon.

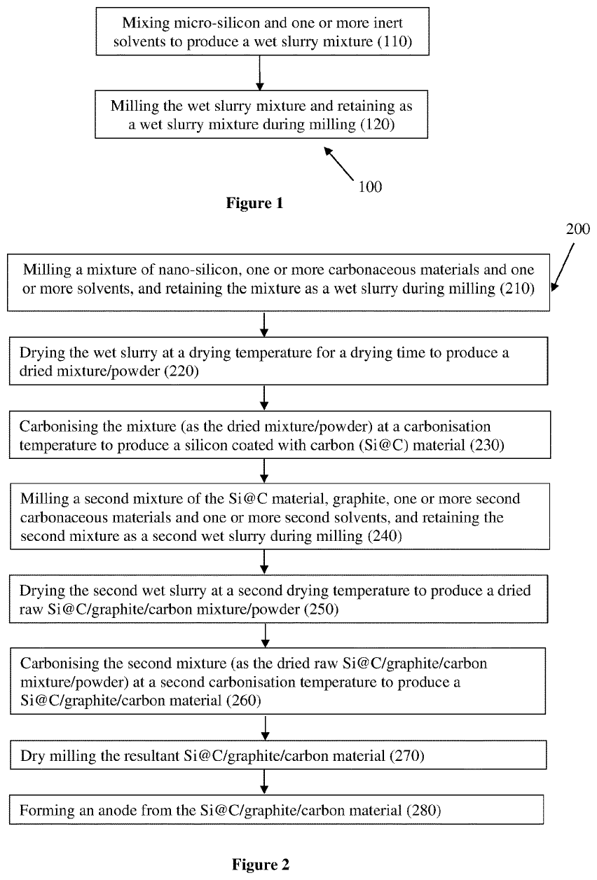

Referring to FIG. 1, there is illustrated a method 100 of producing nano-silicon from micro-silicon. Step 110 includes mixing the micro-silicon and one or more inert solvents to produce a wet slurry mixture. Step 120 includes milling the wet slurry mixture of the micro-silicon and the one or more inert solvents, preferably using sand milling. During step 120, the mixture is retained as a wet slurry mixture (i.e., during milling).

In a particular example, the micro-silicon (micro-Si) has an average particle size of equal to or between about 10 μm and about 100 μm. Preferably, the micro-silicon has an average particle size of about 10 μm, 15 μm, 20 μm, 25 μm, 30 μm, 35 μm, 40 μm, 45 μm, or 50 μm. Most preferably, the micro-silicon has an average particle size of about 10 μm.

Nano-silicon (nano-Si) is produced by sand milling or ball milling (high energy) the micro-silicon in the presence of at least one inert solvent and by retaining the mixture as a wet slurry during milling of the micro-silicon. The average particle size of the obtained nano-silicon is equal to or between about 50 nm and about 500 nm. Preferably, the nano-silicon has an average particle size of about 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490 or 500 nm. Most preferably, the nano-silicon has an average particle size of about 100 nm, for instance, about 50-150, 60-140, 70-130, 80-120, 90-110 nm.

Micro-silicon is pulverised into nano-silicon by grinding in one or more inert solvents via, preferably, sand milling. The inert solvent can be one or more one of ethylene glycol (EG), 1-pentanol, propylene glycol, polyacrylic acid, or similar.

Alternatively, the solvent may be selected from the group consisting of toluene, xylene, quinoline, pyridine and tetrahydrofuran (THF), diethyl ether, di-isopropyl ether, methylethyl ether, dioxane, methanol, ethanol, 1-propanol, isopropanol, n-butanol, t-butanol, ethyl acetate, dimethylacetamide (DMA), dimethylformamide (DMF), dimethylsulfoxide (DMSO), pentane, n-hexanes, cyclohexane, acetonitrile, acetone, chloroform, dichloromethane carbon tetrachloride, ethylene glycol (EG), propylene glycol, polyacrylic acid, or mixtures thereof. In this step, sand milling, or high energy ball milling is required, because grinding micro-silicon requires ultra-high grinding energy. The slurry is intentionally not allowed to dry during the wet milling process, which avoids agglomeration of silicon particles.

b) Fabrication of an Anode for a Lithium-Ion Battery

Example anodes comprising a silicon/graphite/carbon material, for example a Si/C/G material or a Si@C/G/C material, for use in a lithium-ion battery, were fabricated by pyrolysing, sintering or preferably carbonising, a mixture of silicon particles, one or more carbonaceous materials and graphite.

Nano-silicon is obtained for use, as previously described being produced from micro-silicon, or alternatively commercially supplied nano-silicon can be used. The average particle size of the nano-silicon used is preferably equal to or between about 50 nm and about 500 nm. The nano-silicon used may have an average particle size of about 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490 or 500 nm. Most preferably, the nano-silicon used has an average particle size of about 100 nm, for instance, about 50-150, 60-140, 70-130, 80-120, 90-110 nm.

One or more carbonaceous materials are obtained for use. For example, the one or more carbonaceous materials can be functionalised graphene platelets, carbon nanotubes (CNTs), reduced graphene oxide (rGO), pyrolysed carbon derived from precursors such as glucose, sucrose or critic acid (CA), pitch, polyacrylonitrile (PAN), polyvinyl chloride (PVC), poly(diallyl dimethylammonium chloride) (PDDA), poly(sodium 4-styrenesulfonate) (PSS)), polydopamine (PDA), polypyrrole (PPy), or phenolic resin.

Graphite is obtained for use, and the graphite could be natural graphite and/or synthetic graphite. For natural graphite, the spherical type is preferred, while the flake shape is preferred for the synthetic graphite. For example, graphite microspheres can be used having an average size of equal to or between about 1 μm and about 20 μm. Preferably, the graphite microspheres have an average size of about 1, 2, 3, 4, 5, 6, 7, 8, 9, 10, 11, 12, 13, 14, 15, 16, 17, 18, 19 or 20 μm. Most preferably, the graphite microspheres have an average size of about 5μm.

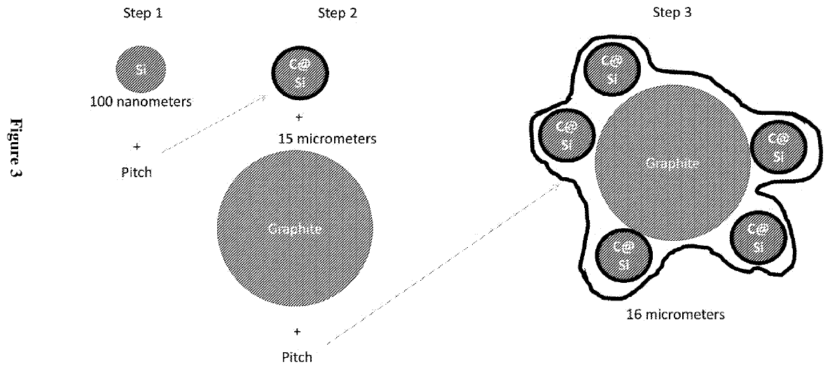

Referring to FIG. 2, there is illustrated a method 200 of fabricating an anode for a lithium-ion battery.

Step 210 includes milling a mixture of nano-silicon, one or more carbonaceous materials and one or more solvents, wherein the mixture is retained as a wet slurry during milling.

Step 220 includes, optionally, drying the wet slurry at a drying temperature for a drying time to produce a dried mixture/powder.

Step 230 includes carbonising the mixture (as the dried mixture/powder if drying step 220 is used) at a carbonisation temperature to produce a silicon coated with carbon (Si@C) material.

Step 240 includes milling a second mixture of the Si@C material, graphite, one or more second carbonaceous materials and one or more second solvents, wherein the second mixture is retained as a second wet slurry during milling.

Step 250 includes, optionally, drying the second wet slurry at a second drying temperature to produce a dried raw “silicon coated with carbon material”(Si@C)/graphite/carbon mixture/powder.

Step 260 includes carbonising the second mixture (as the dried raw

Si@C/graphite/carbon mixture/powder if drying step 250 is used) at a second carbonisation temperature to produce a Si@C/graphite/carbon material.

Step 270 includes milling, preferably dry ball milling, the resultant “silicon coated with carbon material”/graphite/carbon (i.e., Si@C/G/C) material.

Finally, Step 280 includes forming the anode from the Si@C/graphite/carbon material.

Provided below are further non-limiting example method steps for fabricating an anode for a lithium-ion battery according to the present invention.

Step 1: Nano-silicon and at least one carbonaceous material are weighed out in a mass ratio (nano-silicon:carbonaceous material) of equal to or between about 40:60 to about 70:30. Preferably, the mass ratio (nano-silicon:carbonaceous material) is about 40:60, about 50:50, about 60:40, or about 70:30. More preferably, the ratio is about 40:60, 41:59, 42:58, 43:57, 44:56, 45:55, 46:54, 47:53, 48:52, 49:51, about 50:50, 51:49, 52:48, 53:47, 54:46, 55:45, 56:44, 57:43, 58:42, 59:41, about 60:40, 61:39, 62:38, 63:37, 64:36, 65:35, 66:34, 67:33, 68:32, 69:31 or about 70:30. Most preferably, the mass ratio (nano-silicon:carbonaceous material) is about 50:50.

Step 2: The nano-silicon and one or more carbonaceous materials are fully mixed by milling, preferably wet ball milling. One or more solvents, which may be one or more inert solvents, are used during the wet ball milling and can include, for example, toluene, xylene, quinoline, pyridine, tetrahydrofuran (THF), diethyl ether, di-isopropyl ether, methylethyl ether, dioxane, methanol, ethanol, 1-propanol, isopropanol, n-butanol, t-butanol, ethyl acetate, dimethylacetamide (DMA), dimethylformamide (DMF), dimethylsulfoxide (DMSO), pentane, n-hexanes, cyclohexane, acetonitrile, acetone, chloroform, dichloromethane carbon tetrachloride, ethylene glycol (EG), propylene glycol, polyacrylic acid, or mixtures thereof. The volume of the one or more solvents required should be just enough to submerge the solid powder, maintaining the mixture as a wet slurry during grinding via wet ball milling, rather than as a dilute liquid or in a viscous state. Sealing is required during the whole milling process to avoid solvent evaporation.

The speed of ball milling is preferably about 400 rpm, although the speed of ball milling could be about 300 to about 600 rpm, for instance, about 300, 325, 350, 375, 400, 425, 450, 475, 500, 525, 550, 575 or about 600 rpm. The time duration of ball milling is preferably about 6 hours, although the time duration of ball milling could be about 3 to about 24 hours, for instance, about 3, 4, 5, 6, 7, 8, 9, 10, 11, 12, 13, 14, 15, 16, 17, 18, 19, 20, 21, 22, 23 or 24 hours. The ball:weight ratio is preferably about 20:1, although the ball:weight ratio could be about 10:1 to 40:1, for instance, about 10:1, 15:1, 20:1, 25:1, 30:1, 35:1, 40:1, 45:1 or about 50:1.

Step 3: The mixture, being a wet slurry, is vacuum dried in an oven at a drying temperature for a drying time to produce a dried powder. For example, the temperature can be equal to or between about 70° C. and about 150° C. Preferably, the temperature is about 70° C., 80° C., 90° C., 100° C., 110° C., 120° C., 130° C., 140° C. or 150° C. Most preferably, the temperature is about 80° C. The drying time can be equal to or between about 2 hours and about 18 hours. Preferably, the drying time is about 2, 3, 4, 5, 6, 7, 8, 9, 10, 11, 12, 13, 14, 15, 16, 17 or 18 hours. Most preferably, the drying time is about 12 hours.

Step 4: The dried material, i.e., dried powder, is then carbonised, for example in a tube furnace under flowing inert gas, preferably argon gas or nitrogen gas or mixtures thereof, and the resulting Si@C material (i.e., silicon particles coated with carbon material) is collected. Preferably, the process of carbonisation, which can be characterised as high temperature carbonisation, includes the steps of:

heating the dried powder to a holding temperature of about 400° C. (or optionally equal to or between about 300° C. to about 500° C.) at incremental increases of about 5° C. per minute (or optionally equal to or between about 2° C. to about 5° C. per minute),

maintaining the holding temperature of the dried powder at about 400° C. (or optionally equal to or between about 300° C. to about 500° C.) for about 3 hours (or optionally equal to or between about 2 hours to about 5 hours),

further heating the dried powder to a carbonisation temperature of about 1000° C. (or optionally equal to or between a carbonisation temperature range of about 900° C. to about 1200° C., for example the carbonisation temperature can be about 900° C., 950° C., 1000° C., 1050° C., 1100° C., 1150° C. or 1200° C.) at incremental increases of about 8° C. per minute (or optionally equal to or between about 5° C. to about 10° C. per minute),

maintaining the dried powder at the carbonisation temperature for about 5 hours (or optionally equal to or between about 3 hours to about 8 hours), and then

naturally cooling the resultant Si@C material to room temperature, during which time the gas flow rate of the argon gas (or nitrogen gas) is kept stable.

Step 5: Next, the obtained Si@C material, graphite and one or more second carbonaceous materials are weighed out in a mass ratio (Si@C material:graphite:second carbonaceous material) of equal to or between about 10-30:40-80:10-30. Preferably, the mass ratio (Si@C material:graphite:second carbonaceous material) is about 10:80:10, about 10:70:20, about 10:60:30, about 20:70:10, about 20:60:20, about 20:50:30, about 30:60:10, about 30:50:20, or about 30:40:30. Most preferably, the mass ratio (Si@C material:graphite:second carbonaceous material) is about 20:60:20. The one or more second carbonaceous materials used in this step is preferred to be same as the one or more carbonaceous materials previously used, however a different type of one or more second carbonaceous material could be used.

Step 6: The obtained Si@C material, graphite and one or more second carbonaceous materials are fully mixed as a second mixture by milling, preferably wet ball milling. In this step, the Si@C material is integrated with graphite and further coated by the one or more second carbonaceous materials (being utilised for a second time). One or more second solvents, which may be one or more second inert solvents, are used in the milling process and can be one or more of toluene, xylene, quinoline, pyridine, tetrahydrofuran, etc.

The one or more second solvents are preferably the same as the one or more solvents previously used, however may be different solvents. The volume of the one or more second solvents required should be just enough to submerge the solid powder, maintaining the second mixture as a second wet slurry during grinding via wet ball milling, rather than as a dilute liquid or in a viscous state. Sealing is required during the whole milling process to avoid second solvent evaporation.

The speed of ball milling is preferably about 400 rpm, although the speed of ball milling could be about 300 to about 600 rpm. The time duration of ball milling is preferably about 24 hours, although the time duration of ball milling could be about 12 to about 48 hours. The ball:weight ratio is preferably about 20:1, although the ball:weight ratio could be about 10:1 to 40:1.

Step 7: The obtained second mixture, being a second wet slurry, is vacuum dried in an oven at a second drying temperature for a second drying time to produce a dried raw Si@C/G/C material as a powder. For example, the temperature can be equal to or between about 70° C. and about 150° C. Preferably, the temperature is about 70° C., 80° C., 90° C., 100° C., 110° C., 120° C., 130° C., 140° C. or 150° C. Most preferably, the temperature is about 80° C. The drying time can be equal to or between about 6 hours and about 18 hours.

Preferably, the drying time is about 6, 7, 8, 9, 10, 11, 12, 13, 14, 15, 16, 17 or 18 hours. Most preferably, the drying time is about 12 hours.

Step 8: The dried raw Si@C/G/C material (a powder) is then carbonised, for example in a tube furnace under flowing inert gas, preferably argon gas or nitrogen gas or mixtures thereof, and the resulting Si@C/G/C material is collected. Preferably, the process of carbonisation, which can be characterised as high temperature carbonisation, includes the steps of:

heating the dried raw Si @ C/G/C powder to a second holding temperature of about 400° C. (or optionally equal to or between about 300° C. to about 500° C.) at incremental increases of about 5° C. per minute (or optionally equal to or between about 2° C. to about 5° C. per minute),

maintaining the second holding temperature of the Si@C/G/C powder at about 400° C. (or optionally equal to or between about 300° C. to about 500° C.) for about 3 hours (or optionally equal to or between about 2 hours to about 5 hours),

further heating the Si@C/G/C powder to a second carbonisation temperature of about 1000° C. (or optionally a second carbonisation temperature range of equal to or between about 900° C. to about 1200° C., for example the second carbonisation temperature can be about 900° C., 950° C., 1000° C., 1050° C., 1100° C., 1150° C. or 1200° C.) at incremental increases of about 8° C. per minute (or optionally equal to or between about 5° C. to about 10° C. per minute), where the second carbonisation temperature may be the same as, or different to, the carbonisation temperature, and the second carbonisation temperature range may be the same as, or different to, the carbonisation temperature range,

maintaining the Si@C/G/C powder at the second carbonisation temperature for about 5 hours (or optionally equal to or between about 3 hours to about 8 hours), and then

naturally cooling the obtained Si@C/G/C material to room temperature, during which time the gas flow rate of the argon gas is kept stable.

Step 9: After a final grinding via milling, preferably dry ball milling, the resultant final Si@C/G/C material is obtained. The speed of dry ball milling is preferably about 400 rpm, although the speed of dry ball milling could be about 300 rpm to about 500 rpm. The time duration of dry ball milling is preferably about 24 hours, although the time duration of ball milling could be about 12 to about 48 hours. A sufficient time duration and speed is needed to make the resultant material uniform, and the ball milling jar should be filled with an inert gas, such as argon gas, helium gas, nitrogen gas, etc.

Step 10: The Si@C/G/C material shows micro-sized hierarchical structures, where the carbon coated Si nanoparticles are uniformly distributed on the graphite matrix, and a second carbon coating on the whole structure to form a uniform conductive network. To form an anode for use in a lithium-ion battery, the Si@C/G/C material, one or more polymer binders (e.g., CMC+SBR), and a conductive agent (e.g., carbon black) are mixed in proportion (e.g., 8:1:1), uniformly stirred in distilled water to form a uniform slurry, and coated on a clean and flat metallic member (e.g., copper foil), and for the example discussed a Si@C/G/C slurry-coated copper foil is obtained.

The Si@C/G/C slurry-coated copper foil is dried by heating under vacuum for about 12 hours, then the dried Si@C/G/C coated copper foil is cut and pressed, thereby forming a Si@C/G/C anode for use in a lithium-ion battery. An exemplary representation of the resulting Si@C/G/C structure is shown in FIG. 3.

c) Example Lithium-Ion Battery (LIB)

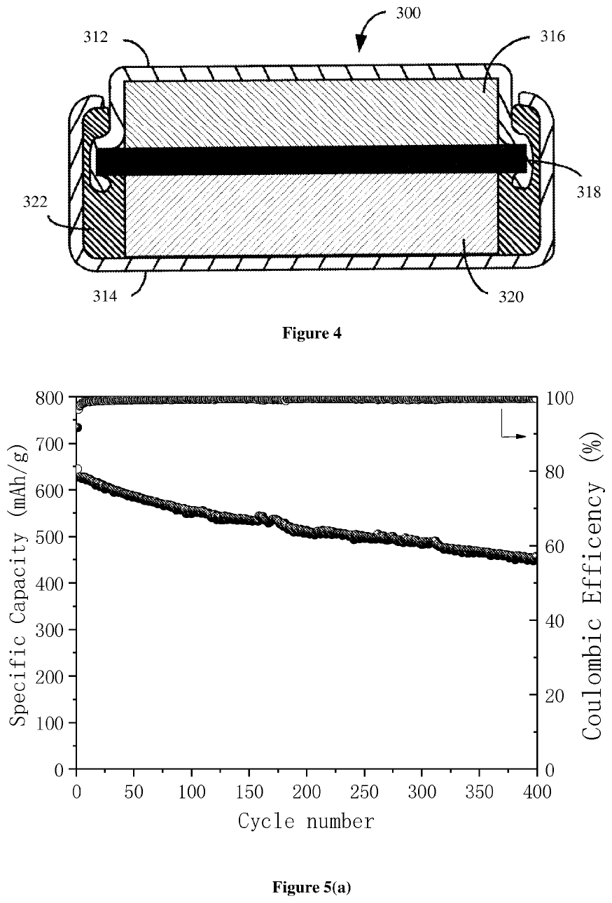

Referring to FIG. 4, there is illustrated an example lithium-ion battery 300 (i.e., lithium-ion cell) including an anode fabricated according to one of the example methods disclosed herein.

FIG. 4 illustrates a coin-on-coin type lithium-ion battery 300 having a first component 312 and a second component 314, which are constructed of a conductive material and can act as electrical contacts. However, it should be noted that the battery 300 can be constructed according to any lithium-ion battery configuration as is known in the art. Within, or attached to, first component 312 is an anode 316 made according to present embodiments, and within, or attached to, second component 314 is a cathode 320, with separator 318 positioned between anode 316 and cathode 320.

An insulator 322 ensures that anode 316 is only in conductive connection with the first component 312 and cathode 20 is only in conductive connection with the second component 314, whereby conductive contact with both the first component 312 and the second component 314 closes an electrical circuit and allows current to flow due to the electrochemical reactions at anode 316 and cathode 320. The coin-on-coin lithium-ion battery configuration as well as other electrode and component configurations are well known in the art and the present inventive anode can be readily configured to any type of lithium-ion battery as would be apparent to a person skilled in the art.

In an example lithium-ion battery configuration using an electrolyte, various electrolytes can be used. An example non-limiting electrolyte includes 1.15 M LiPF₆ in a mixture of ethylene carbonate (EC)/ethyl methyl carbonate (EMC)/ethyl propionate (EP)/fluoroethylene carbonate (FEC) in a weight ratio of 27:35:27:10 (ethylene carbonate (EC):ethyl methyl carbonate (EMC):ethyl propionate (EP):fluoroethylene carbonate (FEC)), with additive agents such as, for example, propylene sulfate (PS) and adiponitrile (AND).

The following Examples provide more detailed discussion that is intended to be merely illustrative and not limiting to the scope of the present invention.

For the following exemplary anodes, the anodes were formed as solid electrodes from the produced materials/powders of each of the Examples. The electrodes were fabricated using a slurry-coating and drying method. To form the anodes the active material (e.g., Si@C/G/C, Si/C/G, Si/G, etc.), a mixture of CMC and SBR (being the one or more polymer binders), and carbon black (being the conductive agent) are mixed in a proportion of equal to or between about 80-96:1-10:3-10, uniformly stirred in distilled water to form a uniform slurry, and coated on a clean and flat copper foil, and a slurry-coated copper foil is obtained. The slurry-coated copper foil is dried by heating under vacuum for about 12 hours, then the dried active material coated copper foil is cut and pressed, thereby forming the anodes for use in the example lithium-ion battery.

The produced anodes were assembled in lithium-ion batteries (i.e., lithium-ion cells) provided as coin-type half CR2032 cells, the galvanostatic charge and discharge measurements were conducted on a Neware™ battery testing system at a constant current density of 200 mA/g within a voltage window of 10 mV to 1.5 V (vs Li+/Li). The electrolyte used includes 1.15 M LiPF₆ in a mixture of ethylene carbonate (EC)/ethyl methyl carbonate (EMC)/ethyl propionate (EP)/fluoroethylene carbonate (FEC) in a weight ratio of 27:35:27:10 (ethylene carbonate (EC):ethyl methyl carbonate (EMC): ethyl propionate (EP):fluoroethylene carbonate (FEC)), with additive agents including propylene sulfate (PS) and adiponitrile (AND).

### Example 1

In an example embodiment, an anode (Example 1) was prepared, labelled a Si@C/G/C-1 anode. The Si@C/G/C-1 anode was prepared using 5.0 g of nano-silicon obtained from sand milling and 5.0 g pitch mixed together with 50 mL of THF (tetrahydrofuran) as a solvent via wet ball milling.

The volume of the THF solvent covered the solid powder, and during wet ball milling the mixture was maintained as a wet slurry during grinding, rather than as a dilute liquid or in a viscous state. Sealing was used during the wet ball milling to avoid evaporation of the THF. The speed of ball milling was 400 rpm, and the duration of ball milling was for 48 hours. The ball:weight ratio was about 20:1. The resulting slurry was vacuum dried overnight in an oven at a temperature of 80° C. for about 12 hours.

The dried powder was then carbonised in a tube furnace under flowing argon gas. During the process of carbonisation, the dried powder was first heated to a holding temperature of 400° C. at incremental increases of 5° C. per minute. The holding temperature of the dried powder was maintained at 400° C. for 3 hours. The dried powder was further heated to a final temperature of 1000° C. at incremental increases of 8° C. per minute. The final temperature of the dried powder was maintained at 1000° C. for 5 hours, and then the resulting Si@C material was allowed to naturally cool to room temperature, during which time the gas flow rate of the argon gas was kept stable. The resulting Si@C material was collected.

Then 5.0 g of the resulting Si@C material, 15.0 g of graphite and 5.0 g of pitch were wet ball milled with THF (50 mL) as a solvent. The volume of the THF solvent submerged the solid powder mixture, maintaining the mixture as a wet slurry during grinding via wet ball milling, rather than as a dilute liquid or in a viscous state. Sealing was used during the milling process to avoid evaporation of the THF solvent. The speed of ball milling was 400 rpm, and the duration of ball milling was about 48 hours. The ball:weight ratio was about 20:1. The obtained slurry was vacuum dried in an oven at a temperature of 80° C. for a drying time of about 12 hours.

The collected dried raw Si@C/G/C powder was then carbonised (second carbonisation step) in a tube furnace under flowing argon gas. During the process of further carbonisation, the dried raw Si@C/G/C powder was first heated to a holding temperature of 400° C. at incremental increases of 5° C. per minute. The holding temperature of the Si@C/G/C powder was maintained at 400° C. for 3 hours. Then, the Si@C/G/C powder was further heated to a final temperature of 1000° C. at incremental increases of 8° C. per minute. The final temperature of the Si@C/G/C powder was maintained at 1000° C. for 5 hours, and then the resulting Si@C/G/C material was allowed to naturally cool to room temperature, during which time the gas flow rate of the argon gas was kept stable. The resulting Si@C/G/C powder was collected.

The Si@C/G/C powder was dry ball milled into a uniform state and the resultant Si@C/G/C material (a powder) was collected. The speed of dry ball milling was 400 rpm, the duration of dry ball milling was about 24 hours, and the ball milling jar was filled with argon gas.

FIG. 5 illustrates the cycling performance of the resulting Si@C/G/C-1 anode. Referring to FIG. 5, the Si@C/G/C-1 anode delivered an average reversible discharge capacity (i.e., specific capacity) of 522.17 mAh/g over 400 cycles. The initial coulombic efficiency (CE) is 80.56%, the CE exceeded 99.0% after 25 cycles and 72.6% of capacity is retained after 400 cycles. This compares favourably, for example, to FIG. 5 of CN 108807861 A (discussed above), which achieved 83% capacity retention after 200 cycles.

### Example 2

A comparative example anode (Example 2) was prepared, labelled a Si/C/G-1 anode (having been carbon coated only one time). The Si/C/G-1 anode was prepared using 2.5 g of nano-silicon obtained from sand milling, 15.0 g of graphite and 7.5 g of pitch being mixed together thoroughly with 50 mL of THF (tetrahydrofuran) as a solvent via wet ball milling, then the resulting slurry was vacuum dried. The collected raw Si/C/G-1 powder was carbonised in a furnace tube, and the Si/C/G-1 powder was finally dry ball milled into a uniform state.

FIG. 5 further illustrates the cycling performance of the resulting Si/C/G-1 anode. Referring to FIG. 5, the Si/C/G-1 anode delivered an average discharge capacity of 487.56 mAh/g over 250 cycles, and a retention of capacity of 78.3%. This result proved that double carbon coating (e.g., as used in Example 1) is beneficial to the electrochemical performance of an anode.

### Example 3

A comparative example anode (Example 3) was prepared, labelled a Si@C/G/C-2 anode (prepared without solvents during ball milling). The Si@C/G/C-2 anode was prepared similarly as for Si@C/G/C-1 (Example 1) except no solvents were used in the ball milling steps and a wet slurry was not retained during ball milling.

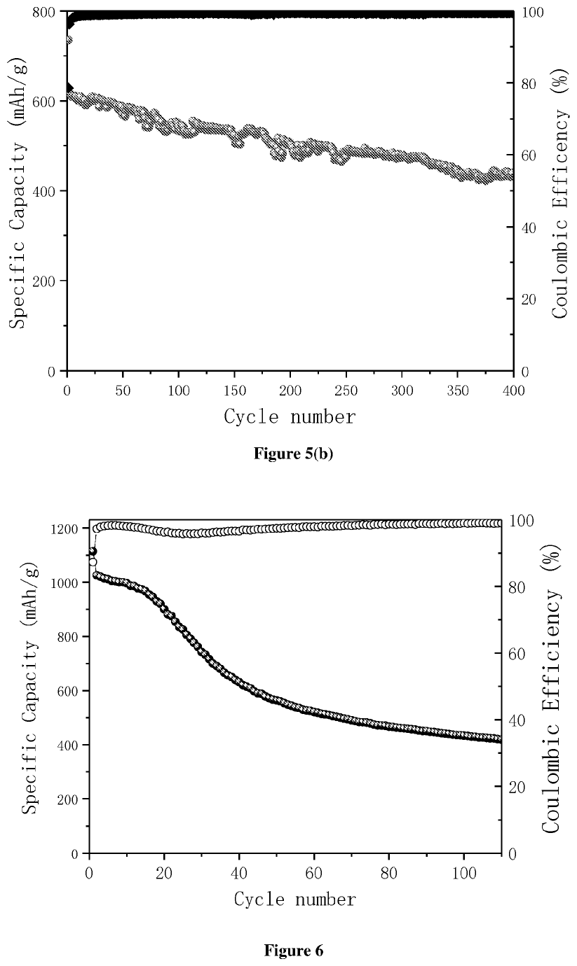

FIG. 6 illustrates the cycling performance of the resulting Si@C/G-2 anode. Referring to FIG. 6, the discharge capacity falls rapidly, and the retention capacity is quite low. It is believed that dry ball milling (i.e., without use of one or more solvents) leads to uneven coating and thus some silicon particles are directly exposed to electrolytes, and that these uncoated silicon particles result in degraded electrochemical performance and poorer cycling ability compared to Example 1.

### Example 4 and Example 5

A comparative example anode (Example 4) was prepared, labelled a Si/G-1 anode (silicon without being carbon coated, but mixed with graphite). Another comparative example anode (Example 5) was prepared, labelled a Si-1 anode (bare silicon without being carbon coated and without being mixed with graphite).

The Si/G-1 anode was prepared using 5.0 g of nano-silicon obtained from sand milling and 20.0 g of graphite being mixed together thoroughly with ethylene glycol (50 mL) via wet ball milling, and after drying, the collected raw Si/G powder was then heat treated in a furnace tube, similarly as for the carbonisation step of Example 1. The Si/G powder was finally dry ball milled into a uniform state. In contrast, the Si-1 anode was prepared after simply collecting the nano-silicon after sand milling.

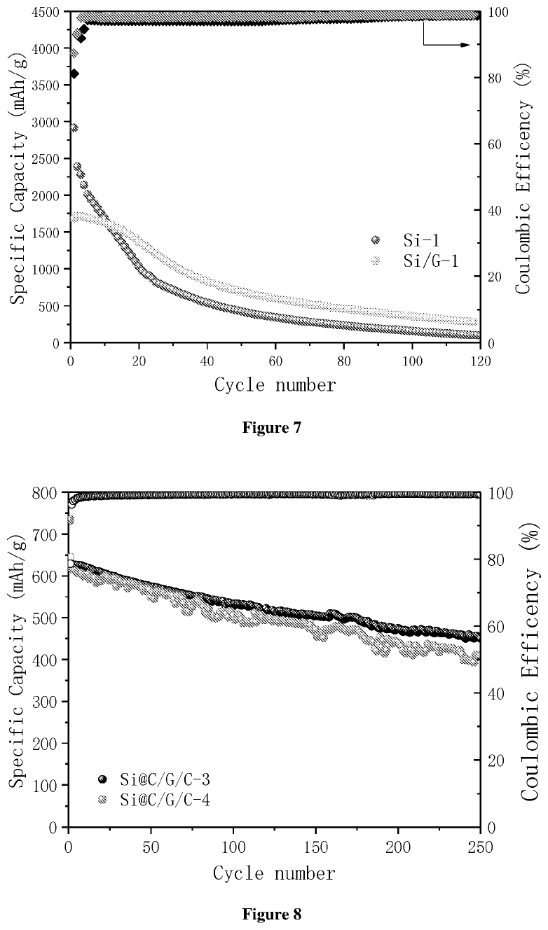

FIG. 7 illustrates the cycling performance of the resulting Si/G-1 anode and the resulting Si-1 anode. Referring to FIG. 7, the Si/G-1 anode and the Si-1 anode can deliver high reversible capacities during initial cycling, but the reversible capacities rapidly decrease after further cycling. Only 28.5% (Si/G-1 anode) and 8.3% (the Si-1 anode) of capacity is retained after 100 cycles. It is believed the reason for the rapid decline of capacity for the Si-1 anode (bare-silicon) is its very large expansion in volume. In contrast, for example the Si/C/G-1 anode (Example 2) and the Si/G-1 anode (Example 4), silicon coated with carbon can effectively alleviate volume expansion of the silicon and prolong cycling life of the anode.

### Example 6 and Example 7

A comparative example anode (Example 6) was prepared, labelled a Si@C/G/C-3 anode (different annealing temperature). Another comparative example anode (Example 7) was prepared, labelled a Si@C/G/C-4 anode (different annealing temperature).

The Si@C/G/C-3 and Si@C/G/C-4 anodes were prepared similarly as for the Si@C/G/C-1 anode (Example 1) except different annealing (i.e., sintering) temperatures were used.

As previously described in Example 1, during the process to fabricate the Si@C/G/C-1 anode, the annealing temperature used during carbonisation was 1000° C. In contrast, during the process to fabricate the Si@C/G/C-3 anode, the annealing temperature used during carbonisation was 800° C. In further contrast, during the process to fabricate the Si@C/G/C-4 anode, the annealing temperature used during carbonisation was 600° C. Other process conditions for fabricating the different anodes were the same.

FIG. 8 illustrates the cycling performance of the resulting Si@C/G/C-3 anode and the resulting Si@C/G/C-4 anode. Referring to FIG. 8, in comparison with the Si@C/G/C-1 anode (Example 1), the Si@C/G/C-3 anode and the Si@C/G/C-4 anode deliver lower capacity retention, retaining 86.01% (Si@C/G/C-3 anode) and 81.47% (Si@C/G/C-4 anode) of capacity after 100 cycles, and 71.4% (Si@C/G/C-3 anode) and of 40.65% (Si@C/G/C-4 anode) capacity after 250 cycles. It is believed that using an annealing temperature that is not sufficiently high does not fully carbonise the carbonaceous materials.

d) Multi Functional Polymer Binder

A multi-functional binder, particularly a relatively low-cost multi-functional polymer binder, was designed and synthesised. The multi-functional polymer binder has a 3D (three-dimensional) network structure, improved electroconductivity, and self-repairing properties. In one example application for anodes for lithium-ion batteries, use of the multi-functional polymer binder as part of an anode assists in addressing the relatively poor conductivity and large volume expansion of an anode, for example a silicon-based anode, which otherwise leads to the problem of rapid capacity decay. It would be appreciated by the person skilled in the art that various other example applications are possible for the multi-functional polymer binder.

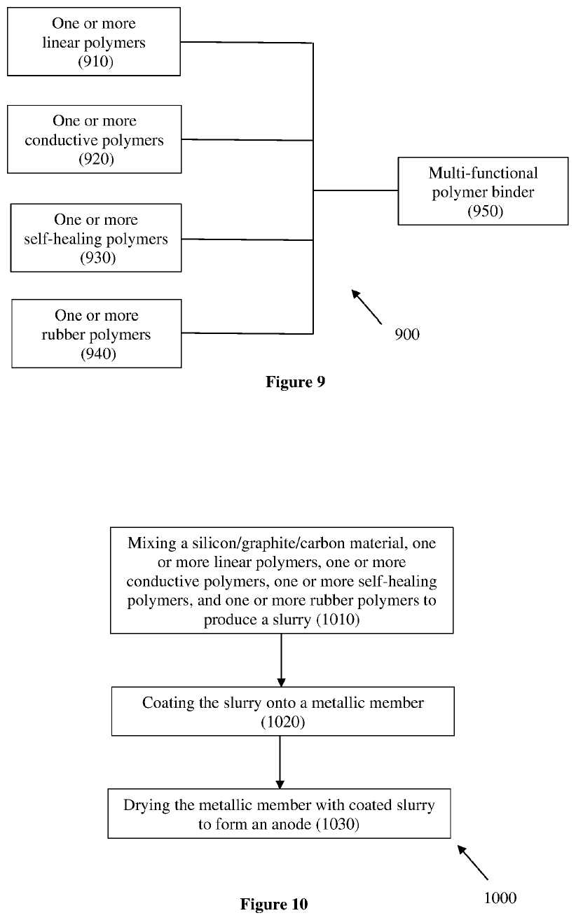

Referring to FIG. 9, there is illustrated a method 900 of producing a multi-functional polymer binder. Method 900 includes mixing together one or more linear polymers 910, one or more conductive polymers 920, one or more self-healing polymers 930 and one or more rubber polymers 940 to produce the multi-functional polymer binder 950.

The composition of an example multi-functional polymer binder includes:

one or more linear polymers at a percentage weight of equal to or between about 20 wt % to about 60 wt %. Preferably the percentage weight of the one or more linear polymers is about 20 wt %, 25 wt %, 30 wt %, 35 wt %, 40 wt %, 45 wt %, 50 wt %, 55 wt % or 60 wt %. In a preferred example, the percentage weight of the one or more linear polymers is about 50 wt %;

one or more conductive polymers at a percentage weight of equal to or between about 5 wt % to about 20 wt %. Preferably the percentage weight of the one or more conductive polymers is about 5 wt %, 10 wt %, 15 wt % or 20 wt %. In a preferred example, the percentage weight of the one or more conductive polymers is about 10 wt %;

one or more self-healing polymers at a percentage weight of equal to or between about 10 wt % to about 20 wt %. Preferably the percentage weight of the one or more self-healing polymers is about 10 wt %, 15 wt % or 20 wt %. In a preferred example, the percentage weight of the one or more self-healing polymers is about 10 wt %; or

one or more rubber polymers at a percentage weight of equal to or between about 10 wt % to about 40 wt %. Preferably the percentage weight of the one or more rubber polymers is about 10 wt %, 15 wt %, 20 wt %, 25 wt %, 30 wt %, 35 wt % or 40 wt %. In a preferred example, the percentage weight of the one or more rubber polymers is about 30 wt %.

Surprisingly, the present inventors have found that the multi-functional binder as described herein when mixed with a silicon/graphite/carbon material (for example, Si@C/G/C) to fabricate an anode for a lithium ion-battery increases at least one of cycle life (cycling performance) of the silicon containing anode and coulombic efficiency of the resulting lithium-ion battery.

Without being bound by any one theory, the present inventors believe that the increase in cycle life and coulombic efficiency is because the multi-functional polymer binder of the present invention is substantially uniformly distributed throughout the silicon/graphite/carbon material in the fabricated anode. Without being bound by any one theory, the present inventors believe that the multi-functional polymer binder is miscible or compatible with the silicon/graphite/carbon material in the fabricated anode resulting in the substantially uniform distribution and the avoidance of SBR migration.

In particular examples, hydroxyl groups, amine groups, or carboxyl groups of linear polymers; imino groups or sulfonic acid groups of conductive polymers; and urea groups of self-healing polymers, are cross-linked to form a 3D network composed of rigid-flexible chains, which increase desirable mechanical properties of the anode and adhesion.

Without being bound by any one theory, the present inventors have also found that the addition of an organic acid, preferably citric acid, can in some embodiments improve the distribution of the binder of the present invention throughout the silicon/graphite/carbon material in the fabricated anode when the slurry is heated by triggering crosslinking of the one or more linear polymers, the one or more conductive polymers, the one or more self-healing polymers, and the one or more rubber polymers. The crosslinked multi-functional polymer binder prevents or ameliorates migration of the rubber polymer to the surface of the electrode thereby providing a more uniform three-dimensional structure.

Preferred linear polymers include, for example, sodium carboxymethyl cellulose (CMC), polyacrylic acid (PAA), lithium polyacrylic acid (LiPAA), polyvinyl alcohol (PVA), citric acid (CA), sodium alginate (SA), 2-pentenoic acid, 2-methacrylic acid, or chitosan (CS).

Preferred conductive polymers include, for example, polyaniline (PANI), sodium poly[9,9-bis(3-propanoate)fluorine] (PFCOONa), poly(1-pyrenemethyl methacrylate-co-methacrylic acid) (PPyMAA), polypyrrole (PPY) or 3,4-ethylenedioxythiophene/polystyrene-4-sulfonate (PEDOT:PSS).

Preferred self-healing polymers include, for example, urea-pyrimidinone (UPy), dopamine methacrylamide (DMA), and dopamine (DA).

Preferred rubber polymers include, for example, styrene butadiene rubber (SBR), neoprene, nitrile rubber, butyl silicone rubber, or polysulfide rubber. In a preferred embodiment, the rubber polymer is a styrene butadiene rubber (SBR) and derivatives thereof.

In some embodiments, the one or more linear polymers has a weight average molecular weight of 20,000 to 1,000,000 Daltons. In some embodiments, the weight average molecular weight is of from 20,000 to 600,000 Daltons. In some embodiments, the weight average molecular weight is of from 50,000 to 600,000 Daltons. In some embodiments, the weight average molecular weight is of from 10,0000 to 600,000 Daltons. In some embodiments, the weight average molecular weight is of from 500,000 to 550,000 Daltons. In some embodiments, the weight average molecular weight is 520,000 Daltons.

In some embodiments, the weight average molecular weight is of from 50,000 to 150,000 Daltons. In some embodiments, the number average molecular weight is of from 100,000 to 200,000 Daltons.

In some embodiments, the one or more conductive polymers has a weight average molecular weight of 20,000 to 1,000,000 Daltons. In some embodiments, the weight average molecular weight is of from 20,000 to 600,000 Daltons. In some embodiments, the weight average molecular weight is of from 50,000 to 600,000 Daltons. In some embodiments, the weight average molecular weight is of from 100,000 to 600,000 Daltons. In some embodiments, the weight average molecular weight is of from 500,000 to 550,000 Daltons. In some embodiments, the weight average molecular weight is 520,000 Daltons. In some embodiments, the weight average molecular weight is of from 50,000 to 150,000 Daltons. In some embodiments, the number average molecular weight is of from 100,000 to 200,000 Daltons.

In some embodiments, the one or more self-healing polymers has a weight average molecular weight of 20,000 to 1,000,000 Daltons. In some embodiments, the weight average molecular weight is of from 20,000 to 600,000 Daltons. In some embodiments, the weight average molecular weight is of from 50,000 to 600,000 Daltons. In some embodiments, the weight average molecular weight is of from 100,000 to 600,000 Daltons. In some embodiments, the weight average molecular weight is of from 500,000 to 550,000 Daltons. In some embodiments, the weight average molecular weight is 520,000 Daltons. In some embodiments, the weight average molecular weight is of from 50,000 to 150,000 Daltons. In some embodiments, the number average molecular weight is of from 100,000 to 200,000 Daltons.

In some embodiments, the one or more rubber polymers has a weight average molecular weight of 20,000 to 1,000,000 Daltons. In some embodiments, the weight average molecular weight is of from 20,000 to 600,000 Daltons. In some embodiments, the weight average molecular weight is of from 50,000 to 600,000 Daltons. In some embodiments, the weight average molecular weight is of from 100,000 to 600,000 Daltons. In some embodiments, the weight average molecular weight is of from 500,000 to 550,000 Daltons. In some embodiments, the weight average molecular weight is 520,000 Daltons. In some embodiments, the weight average molecular weight is of from 50,000 to 150,000 Daltons. In some embodiments, the number average molecular weight is of from 100,000 to 200,000 Daltons.

In certain embodiments, the one or more linear polymers, one or more conductive polymers, one or more self-healing polymers and/or one or more rubber polymers are block copolymers. In certain embodiments, the one or more linear polymers, one or more conductive polymers, one or more self-healing polymers and/or one or more rubber polymers are random copolymers.

e) Fabrication of Anode with Binder for Lithium-Ion Battery

In a further exemplary embodiment, an example anode for use in a lithium-ion battery also includes a multi-functional binder, for example as disclosed herein, preferably a multi-functional polymer binder.

The electrochemical performance of the as-prepared anode materials described previously was further improved by improving the electrode structure. A multi-functional binder, as disclosed herein, can be used as part of the anode. The multi-functional binder has a 3D (three-dimensional) network structure, improved electroconductivity, and self-repairing properties, which address the relatively poor conductivity and large volume expansion of a silicon-based anode for lithium-ion batteries (LIBs), which leads to the problem of rapid capacity decay.

Referring to FIG. 10, there is illustrated a method 1000 of fabricating an anode for a lithium-ion battery. Step 1010 includes mixing a silicon/graphite/carbon material, one or more linear polymers, one or more conductive polymers, one or more self-healing polymers, and one or more rubber polymers to produce a slurry. The silicon/graphite/carbon material can be an example as previously disclosed, for example a Si@C/G/C or Si/C/G powder material or can be a mixture of raw Silicon (Si), Graphite (G) and Carbon (C) (the active materials). Optionally, step 1010 can also include mixing a conductive agent as part of the slurry. The conductive agent may be, for example, carbon black, carbon nanotubes, nano-carbon fibers or a mixture thereof as a conductive slurry. Step 1020 includes coating the slurry onto a metallic member, for example a metallic foil, strip or grid. Step 1030 includes drying the metallic member with coated slurry to form the anode.

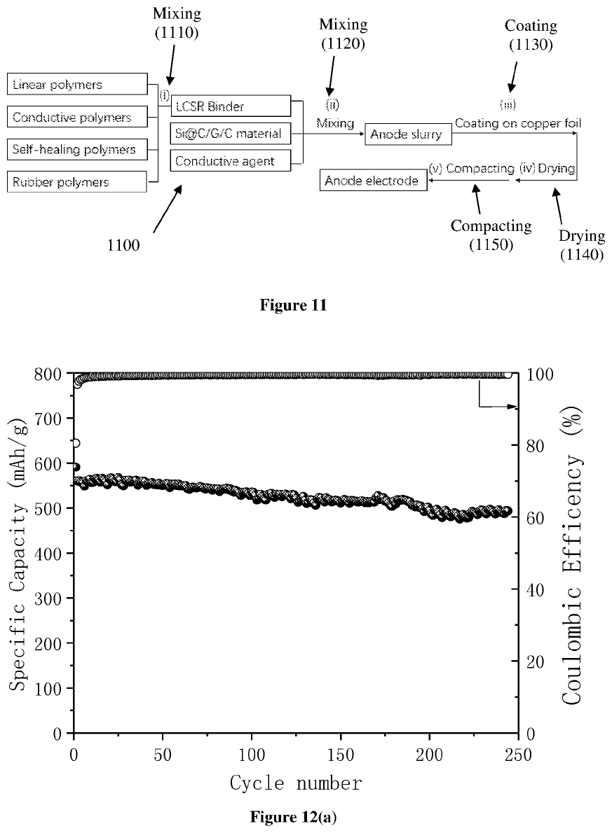

Provided below, and with reference to FIG. 11, is a further non-limiting example method 1100 for fabricating an anode including a multi-functional polymer binder for a lithium-ion battery.

Step 1110: one or more linear polymers, one or more conductive polymers, one or more self-healing polymers, and one or more rubber polymers are weighed out in a mass ratio (linear polymer:conductive polymer:self-healing polymer:rubber polymer) in weight percentages and mass ratios as described herein.

Step 1120: A silicon/graphite/carbon material, which can be an example as previously disclosed, for example as a Si@C/G/C or Si/C/G powder, or can be a mixture of raw Silicon (Si), Graphite (G) and Carbon (C) (the active materials), is homogenously mixed with a conductive agent (for example carbon black, carbon nanotubes, nano-carbon fibers or a mixture thereof as a conductive slurry) and the multi-functional polymer binder at a mass ratio (active materials:conductive agent:multi-functional polymer binder) of equal to or between about 80-96:1-10:3-10. Preferably, the mass ratio (active materials:conductive agent:multi-functional polymer binder) is about 80:10:10, about 85:10:5, about 85:9:6, about 85:8:7, about 85:7:8, about 85:6:9, about 85:5:10, about 90:7:3, about 90:6:4, about 90:5:5, about 90:4:6, about 90:3:7, about 90:2:8, about 90:1:9, about 95:2:3, about 95:1:4, or about 96:1:3. Most preferably, the mass ratio (active materials: conductive agent:multi-functional polymer binder) is about 80:10:10.

In some embodiments, the multi-functional polymer binder is sufficiently conductive such that a conductive agent is not required. In these embodiments, the silicon/graphite/carbon material, and a mixed combination of the one or more linear polymers, the one or more conductive polymers, the one or more self-healing polymers and the one or more rubber polymers, are mixed together in a mass ratio (silicon/graphite/carbon material:mixed combination of polymers) of about 80-99:1-20, 85-99:1-15, 90-99:1-10, 95-99:1-5, 96:4, 97:3, 98:2 or 99:1.

The mixing time can be equal to or between about 2 hours and about 5 hours. Preferably, the mixing time is about 2 hours, 3 hours, 4 hours or 5 hours. Most preferably, the mixing time is about 2 hours.

Step 1130: The resulting slurry is coated onto a metallic member, for example a metallic foil, strip or grid, preferably a copper member provided as a copper foil, which should be kept clean and flat. Other metallic members could be made of, for example, nickel, zinc, aluminium, gold, silver.

Step 1140: The obtained metallic member (for example copper foil) coated with the slurry of anode material is dried in a vacuum oven at a specified drying temperature for a specified drying time. For example, the drying temperature can be equal to or between about 100° C. and about 180° C. Preferably, the temperature is about 100° C., 110° C., 120° C., 130° C., 140° C., 150° C., 160° C., 170° C. or 180° C. Most preferably, the temperature is about 100° C. The drying time can be equal to or between about 10 hours and about 18 hours. Preferably, the drying time is about 10, 11, 12, 13, 14, 15, 16, 17 or 18 h. Most preferably, the drying time is about 12 h.

Step 1150: The produced dried composite material is then compacted before being used as an anode in the assembled lithium-ion battery (i.e., lithium-ion cell).

### Example 8

In an example embodiment, an anode (Example 8) was prepared, labelled a Si@C/G/C-5 anode (i.e., “5:1” anode, with multi-functional polymer binder).

The Si@C/G/C-5 anode was prepared using the same method as for the Si@C/G/C-1 anode (Example 1), other than that a binder including CMC (a linear polymer) and SBR (a rubber polymer) was used with the Si@C/G/C-1 anode (Example 1), while in contrast a multi-functional polymer binder including CMC (a linear polymer), PPY (a conductive polymer), DA and/or UOAA (a self-healing polymer), and SBR (a rubber polymer) was used with the Si@C/G/C-5 anode (Example 8). Other conditions were same in preparing the anodes.

The Si@C/G/C-5 anode was prepared using a mass ratio of the polymers (CMC:PPY:DA/UOAA:SBR) of 40:20:20:20. The conductive agent used was a type of carbon black sold under the trade name Super P™ by TIMCAL Graphite & Carbon, Switzerland. Then, the active material, conductive agent and multi-functional polymer binder was mixed in a mass ratio (Si@C/G/C:conductive agent:multi-functional polymer binder) of 80:10:10 for a mixing time of 2 hours. The resulting slurry was coated onto a copper foil, which was kept clean and flat. The obtained copper foil coated with the slurry of anode material was dried in a vacuum oven at a drying temperature of 100° C. for a drying time 12 hours. The produced dried composite material was then compacted and used as an anode in the assembled lithium-ion battery.

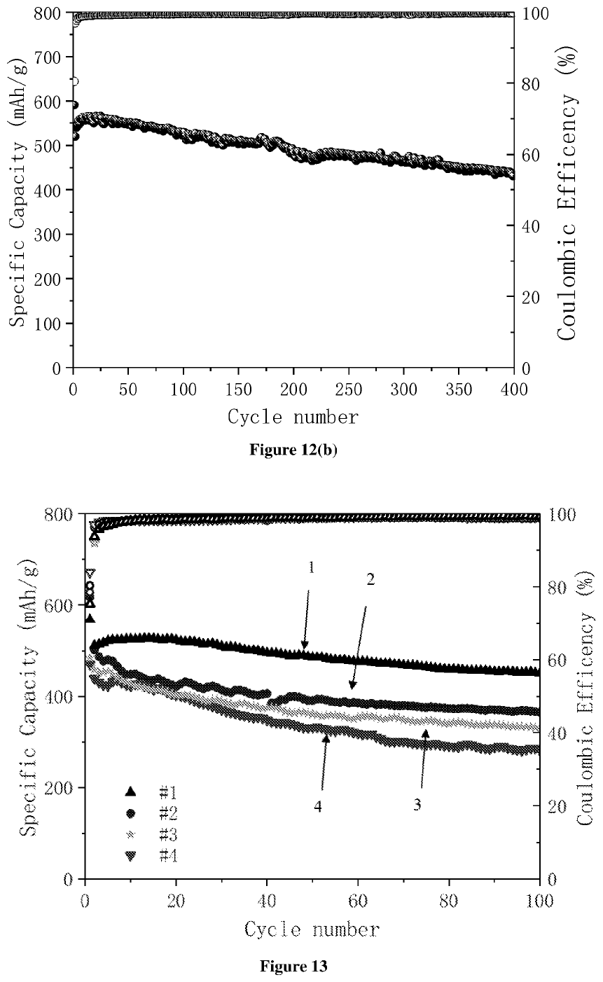

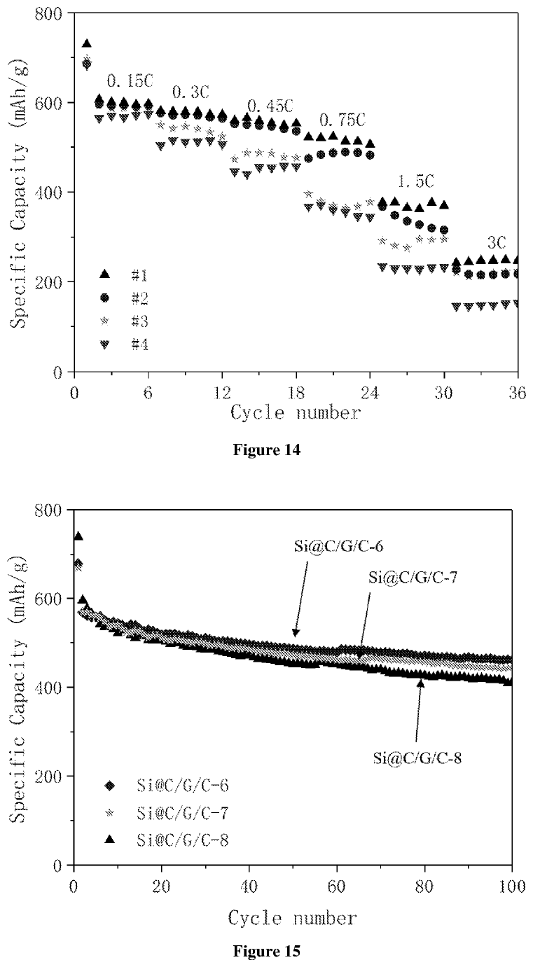

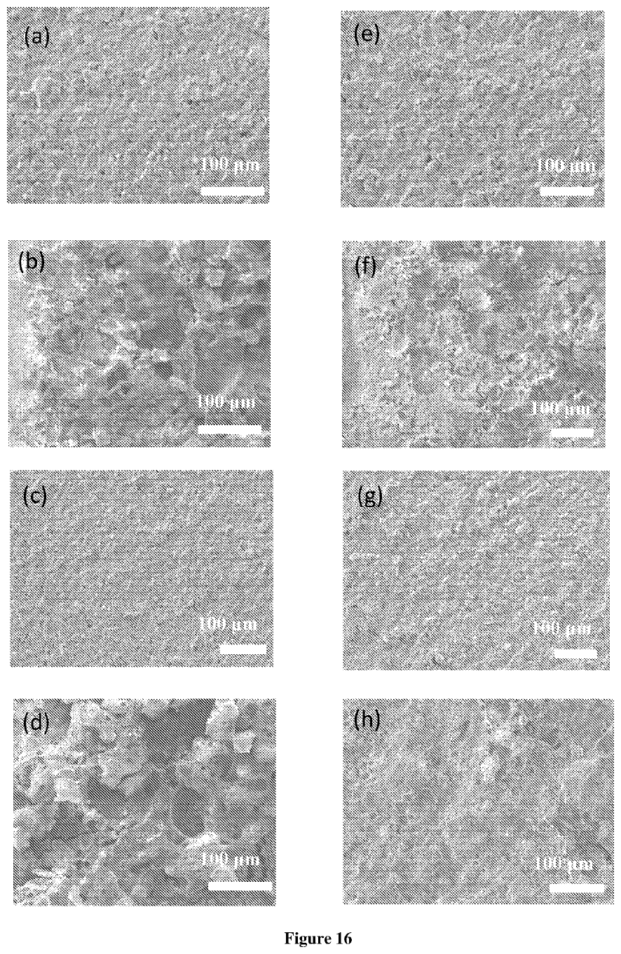

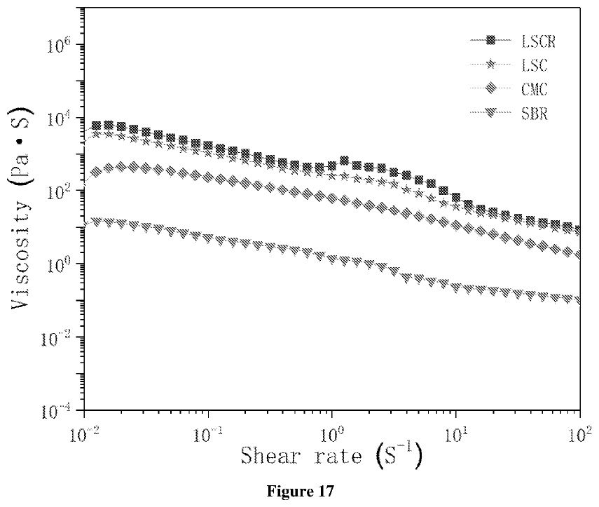

FIG. 12(a) illustrates the cycling performance of an example anode with the LSCR binder (Example 2) labelled a Si@C/G/C-5 anode. The Si@C/G/C-5 anode delivered an average reversible discharge capacity of about 525.7 mAh/g over 250 cycles. CE exceed 99.0% after 13 cycles, and 95.35% of capacity can be retained after 100 cycles, and 89.2% of capacity was retained after 250 cycles, which is an improved electrochemical performance compared to the Si@C/G/C-1 anode which used a standard CMC:SBR binder (Example 1). FIG. 12(b) illustrates the cycling performance of an example anode with the LSCR binder labelled a Si@C/G/C-5 anode over 400 cycles. 82.8% of capacity was retained after 400 cycles, which is an improved electrochemical performance compared to the Si@C/G/C-1 anode, over 400 cycles, using the LSCR binder (Example 1).

Optional embodiments may also be said to broadly include the parts, elements, steps and/or features referred to or indicated herein, individually or in any combination of two or more of the parts, elements, steps and/or features, and wherein specific integers are mentioned which have known equivalents in the art to which the invention relates, such known equivalents are deemed to be incorporated herein as if individually set forth.

Although a preferred embodiment has been described in detail, it should be understood that many modifications, changes, substitutions or alterations will be apparent to those skilled in the art without departing from the scope of the present invention.

1. A method of fabricating an anode for a lithium-ion battery, comprising the steps of:
milling a mixture of nano-silicon, one or more carbonaceous materials and one or more solvents, wherein the mixture is retained as a wet slurry during milling;
carbonising the mixture at a carbonisation temperature to produce a silicon thinly coated with carbon (Si@C) material;
milling a second mixture of the Si@C material, graphite, one or more second carbonaceous materials and one or more second solvents, wherein the second mixture is retained as a second wet slurry during milling;
carbonising the second mixture at a second carbonisation temperature to produce a Si@C/graphite/carbon material; and
forming the anode from the Si@C/graphite/carbon material.

2. A method according to claim 1, further comprising the step of drying the wet slurry at a drying temperature prior to carbonising the mixture.

3. A method according to claim 1, further comprising the step of drying the second wet slurry at a second drying temperature prior to carbonising the second mixture.

4. (canceled)

5. A method according to claim 1, wherein the nano-silicon and the one or more carbonaceous materials are mixed in a mass ratio (nano-silicon:carbonaceous material) of equal to or between about 40:60 to about 70:30.

6. A method according to claim 1, wherein the average particle size of the nano-silicon is equal to or between about 50 nm and about 500 nm.

7-8. (canceled)

9. A method according to claim 1, wherein the graphite is synthetic flake graphite or graphite microspheres having an average size of equal to or between about 1 μm and about 20 μm.

10-12. (canceled)

13. A method according to claim 1, wherein the carbonisation temperature is equal to or between about 900° C. to about 1200° C.

14-15. (canceled)

16. A method according to claim 1, wherein the Si@C material, the graphite and the one or more second carbonaceous materials are mixed in a mass ratio (Si@C material:graphite:second carbonaceous material) of equal to or between about 10-30:40-80:10-30.

17-18. (canceled)

19. A method according to claim 1, wherein the second carbonisation temperature is equal to or between about 900° C. to about 1200° C.

20-22. (canceled)

23. A method according to claim 1, further comprising mixing the Si@C/graphite/carbon material with one or more polymer binders.

24. A method according to claim 23, wherein the one or more polymer binders include one or more linear polymers, one or more conductive polymers, one or more self-healing polymers, and one or more rubber polymers.

25. A method according to claim 23, wherein the anode is formed by:
mixing the Si@C/graphite/carbon material and the one or more polymer binders to produce a slurry;
coating the slurry onto a metallic member; and
drying the metallic member with coated slurry to form the anode.

26. A method of fabricating an anode for a lithium-ion battery, comprising the steps of:
mixing micro-silicon and one or more inert solvents to produce a wet slurry mixture; and
milling the wet slurry mixture of the micro-silicon and the one or more inert solvents to obtain nano-silicon, wherein the mixture is retained as a wet slurry mixture during milling;
milling a mixture of the nano-silicon, one or more carbonaceous materials and one or more solvents, wherein the mixture is retained as a wet slurry during milling;
carbonising the mixture at a carbonisation temperature to produce a silicon coated with carbon (Si@C) material;
milling a second mixture of the Si@C material, graphite, one or more second carbonaceous materials and one or more second solvents, wherein the second mixture is retained as a second wet slurry during milling;
carbonising the second mixture at a second carbonisation temperature to produce a Si@C/graphite/carbon material;
mixing the Si@C/graphite/carbon material, one or more linear polymers, one or more conductive polymers, one or more self-healing polymers, and one or more rubber polymers to produce a slurry;
coating the slurry onto a metallic member; and
drying the metallic member with coated slurry to form the anode.

27. (canceled)

28. An anode for a lithium-ion battery, comprising a Si@C/graphite/carbon material.

29. A lithium-ion battery, comprising:
an anode according to claim 28;
a cathode; and
an electrolyte and/or a separator positioned between the anode and the cathode.
